(19) United States
(12) Patent Application Publication
(10) Pub. No.: US 2026/0252636 A1
(43) Pub. Date: Aug. 27, 2026

(54) SYSTEM

(71) Applicant: SoftBank Group Corp., Tokyo (JP)

(72) Inventor: Hideyuki KOSEKI, Tokyo (JP)

(73) Assignee: SoftBank Group Corp., Tokyo (JP)

(21) Appl. No.: 19/536,216

(22) Filed: Feb. 11, 2026

(30) Foreign Application Priority Data
Feb. 21, 2025 (JP) 2025-026993

(51) Int. Cl. G06F 16/951

(52) U.S. Cl. CPC G06F 16/951

(57) ABSTRACT

The system according to the embodiment comprises a receiving unit, an analysis unit, a storage unit, and a ranking unit. The receiving unit receives inputs of prompts and work processes. The analysis unit analyzes information received by the receiving unit. The storage unit stores information analyzed by the analysis unit as recipes. The ranking unit ranks recipes stored by the storage unit.

### CROSS-REFERENCE TO RELATED APPLICATION

The present application claims priority to and incorporates by reference the entire contents of Japanese Patent Application No. 2025-026993 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that it is difficult to efficiently manage prompts and work processes for generative AI and to find optimal recipes.

### SUMMARY OF THE INVENTION

The system according to the embodiment comprises a receiving unit, an analysis unit, a storage unit, and a ranking unit. The receiving unit receives inputs of prompts and work processes. The analysis unit analyzes information received by the receiving unit. The storage unit stores information analyzed by the analysis unit as recipes. The ranking unit ranks recipes stored by the storage unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

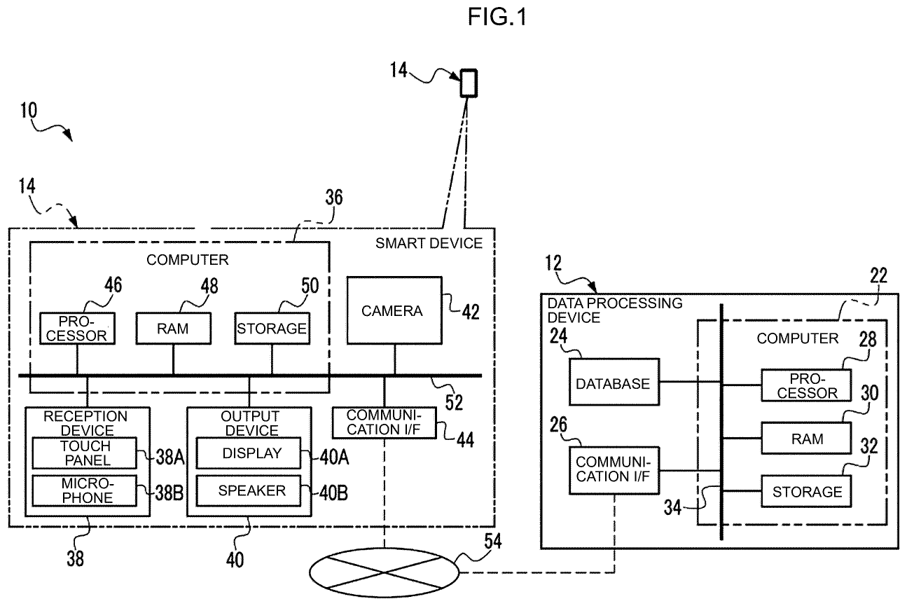

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

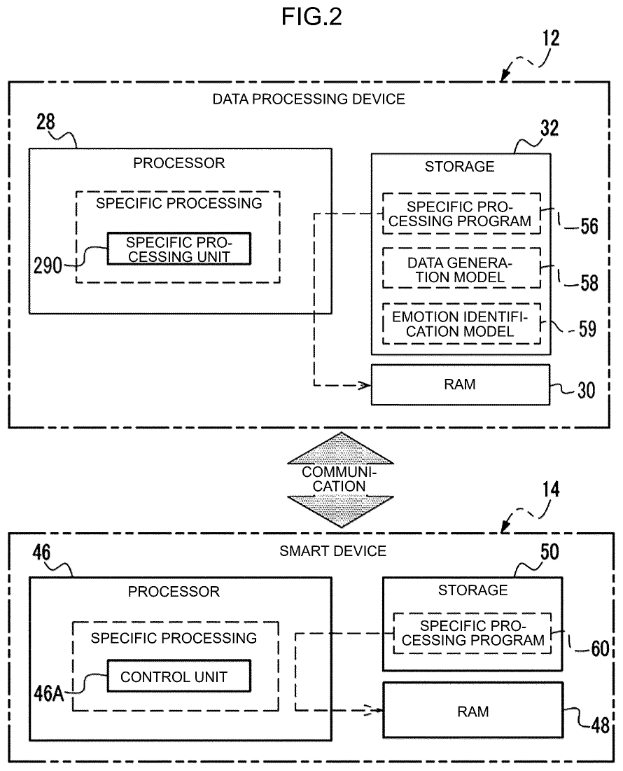

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The generative AI recipe system according to the embodiment of the present invention is a system that saves prompts and work processes for utilizing generative AI as recipes, and creates rankings by page views (PV) or number of users, similar to a recipe sharing site. This generative AI recipe system allows users to input prompts and work processes for utilizing generative AI, saves the entered prompts and work processes as recipes, and ranks the saved recipes by PV or number of users, thereby enabling the system to become the No.1 generative AI recipe portal service. For example, a user inputs prompts and work processes for utilizing generative AI. For instance, specific instructions and procedures for utilizing generative AI, such as “prompt for text generation” and “prompt for image generation,” are entered. This information is input into the system. Next, the entered prompts and work processes are saved as recipes. The system saves the entered information in a database so that users can refer to it later. For example, the “prompt for text generation” and the “prompt for image generation” are each saved as recipes. The saved recipes are ranked by PV or number of users. The system aggregates the PV and number of users for each recipe and creates a ranking. For example, recipes with the highest PV or those used by the most users are ranked at the top. Through this mechanism, by becoming the No.1 generative AI recipe, the system can establish its position as a portal service. Users can refer to the ranking and use the most popular recipes. In addition, recipes ranked at the top are widely used by other users, thereby promoting the utilization of generative AI. For example, if a prompt for text generation is ranked at the top, many users can use that prompt for text generation. Similarly, if a prompt for image generation is ranked at the top, many users can use that prompt for image generation. In this way, the utilization of generative AI spreads, and the position as a portal service is established. As a result, the generative AI recipe system can efficiently save and rank prompts and work processes for utilizing generative AI. Specifically, this generative AI recipe system receives, at the receiving unit, prompts entered by users (e.g., for text generation: “Describe the features of a new product in 100 characters,” for image generation: “Depict a spring landscape with blue sky and cherry blossoms,” etc.) and work processes (e.g., procedures for performing data cleaning in advance and sequentially inputting to the AI model, or procedures for applying automatic correction processing after image generation, etc.) as structured data (such as JSON format or RDB table structure). The system analyzes the data received at the receiving unit using natural language processing algorithms (e.g., Transformer-based large language models, CNN/RNN, etc.) at the analysis unit, extracting the intent of the prompt, decomposing the steps of the work process, and estimating related AI models. The analysis unit tokenizes the input data, converts it into feature vectors (e.g., 512-dimensional embedding vectors), and inputs it to the AI model. For example, in the “text generation” category, the AI model classifies the purpose (summarization, translation, creation, etc.) from the input prompt and analyzes each step of the work process as a time-series tensor. For image generation, the prompt is converted into an input tensor (e.g., text embedding+noise vector) for the image generation AI (e.g., diffusion model or GAN), and saved together with metadata of the generated image. The storage unit stores the analysis results as structured data in the database, including recipe ID, prompt content, work process details, AI model type, generated result samples, and metadata (creation date, user ID, etc.). During storage, data normalization, duplicate elimination, and version management (e.g., management of recipe update history) are also performed. The ranking unit aggregates PV (page views: unique access count, repeat access count, etc.), number of users (unique user ID count, active user count, etc.), and user evaluations (five-level ratings, number of comments, etc.) for each saved recipe, and applies ranking algorithms (e.g., weighted scoring, time-series trend correction, etc.) to determine the ranking. The ranking is updated in real time and output in visualization formats such as graphs or heat maps by the display unit. Examples of AI model input/output include: input: prompt “Describe the features of a new product in 100 characters,” work process “Summarize with AI model A→Proofread with AI model B”→output: summary “This product is a next-generation device that achieves high efficiency and low power consumption.”; or input: prompt “Depict a spring landscape with blue sky and cherry blossoms,” work process “Generate with image generation AI→Automatic color correction”→output: generated image file+metadata, etc. As a subsequent process, top-ranked recipes are automatically featured on special pages, and user feedback and automatic tagging by AI are performed. As a technical effect, this system realizes automatic analysis, classification, and ranking of large-scale data, which is difficult to achieve with simple human recipe sharing, and brings optimization of prompts and work processes, improvement of user experience, aggregation and reusability of AI utilization know-how, and overall system processing efficiency (e.g., fast search using cache or distributed DB). Application fields include AI utilization education platforms, in-company AI business automation support, creative production support, and research and development knowledge sharing infrastructure.

The generative AI recipe system according to the embodiment comprises a receiving unit, an analysis unit, a storage unit, and a ranking unit. The receiving unit receives input of prompts and work processes for utilizing generative AI from users. Prompts may include, for example, question formats or instruction formats, but are not limited thereto. Work processes may include, for example, step-by-step procedures or types of work, but are not limited thereto. The receiving unit, for example, inputs prompts and work processes entered by users into the system. The analysis unit analyzes information received by the receiving unit using generative AI. The analysis may include, for example, data analysis methods or analysis objectives, but is not limited thereto. For example, the analysis unit analyzes the content of prompts and work processes using generative AI and extracts information to be saved as recipes. The storage unit saves information analyzed by the analysis unit as recipes. Recipes may include, for example, cooking recipes or work procedure manuals, but are not limited thereto. The storage unit, for example, saves analyzed information in a database so that users can refer to it later. The ranking unit ranks recipes saved by the storage unit. Ranking may include, for example, evaluation criteria or scoring methods, but is not limited thereto. For example, the ranking unit aggregates PV and number of users for recipes and creates a ranking. Thus, the generative AI recipe system according to the embodiment can efficiently save and rank prompts and work processes for utilizing generative AI. Specifically, this generative AI recipe system receives, at the receiving unit, prompts entered by users (e.g., for text generation: “Describe the features of a new product in 100 characters,” for image generation: “Depict a spring landscape with blue sky and cherry blossoms,” etc.) and work processes (e.g., procedures for performing data cleaning in advance and sequentially inputting to the AI model, or procedures for applying automatic correction processing after image generation, etc.) as structured data (such as JSON format or relational database table structure). The system analyzes the data received at the receiving unit using natural language processing algorithms (e.g., Transformer-based large language models, convolutional neural networks, recurrent neural networks, etc.) at the analysis unit, extracting the intent of the prompt, decomposing the steps of the work process, and estimating related AI models. The analysis unit tokenizes the input data, converts it into feature vectors (e.g., 512-dimensional embedding vectors), and inputs it to the AI model. For example, in the “text generation” category, the AI model classifies the purpose (summarization, translation, creation, etc.) from the input prompt and analyzes each step of the work process as a time-series tensor. For image generation, the prompt is converted into an input tensor (e.g., text embedding+noise vector) for the image generation AI (e.g., diffusion model or generative adversarial network), and saved together with metadata of the generated image. The storage unit stores the analysis results as structured data in the database, including recipe ID, prompt content, work process details, AI model type, generated result samples, and metadata (creation date, user ID, etc.). During storage, data normalization, duplicate elimination, and version management (e.g., management of recipe update history) are also performed. The ranking unit aggregates PV (page views: unique access count, repeat access count, etc.), number of users (unique user ID count, active user count, etc.), and user evaluations (five-level ratings, number of comments, etc.) for each saved recipe, and applies ranking algorithms (e.g., weighted scoring, time-series trend correction, etc.) to determine the ranking. The ranking is updated in real time and output in visualization formats such as graphs or heat maps by the display unit. Examples of AI model input/output include: input: prompt “Describe the features of a new product in 100 characters,” work process “Summarize with AI model A→Proofread with AI model B”→output: summary “This product is a next-generation device that achieves high efficiency and low power consumption.”; or input: prompt “Depict a spring landscape with blue sky and cherry blossoms,” work process “Generate with image generation AI→Automatic color correction”→output: generated image file+metadata, etc. As a subsequent process, top-ranked recipes are automatically featured on special pages, and user feedback and automatic tagging by AI are performed. As a technical effect, this system realizes automatic analysis, classification, and ranking of large-scale data, which is difficult to achieve with simple human recipe sharing, and brings optimization of prompts and work processes, improvement of user experience, aggregation and reusability of AI utilization know-how, and overall system processing efficiency (e.g., fast search using cache or distributed database). Application fields include AI utilization education platforms, in-company AI business automation support, creative production support, and research and development knowledge sharing infrastructure.

The ranking unit may comprise an aggregation unit configured to aggregate page views (PV) or the number of users of recipes. The aggregation unit may, for example, aggregate PV (page views) of recipes. PV may include, for example, unique views or repeat views, but is not limited thereto. For example, the aggregation unit aggregates PV for each recipe and creates a ranking. The aggregation unit may also aggregate the number of users of recipes. The number of users may include, for example, unique users or active users, but is not limited thereto. For example, the aggregation unit aggregates the number of users for each recipe and creates a ranking. By aggregating PV and the number of users of recipes, the accuracy of ranking is improved. Some or all of the above-described processing in the aggregation unit may be performed using AI or without using AI. For example, the aggregation unit may use an AI model that takes PV and the number of users of recipes as input and outputs aggregation results to perform aggregation. Specifically, the aggregation unit extracts page view information (e.g., structured records including access date and time, user ID, session ID, device type, etc.) from the access log database for each recipe, and implements an algorithm that distinguishes and counts unique views (number of accesses per different user ID) and repeat views (multiple accesses by the same user). For aggregation of the number of users, the aggregation unit generates a hashed list of unique user IDs and calculates multiple indicators such as the number of active users (e.g., number of users who accessed at least once in the last 30 days) and the number of new users (number of first-time access users). These aggregation processes are executed quickly using distributed databases or in-memory aggregation engines. When using AI models, the aggregation unit receives time-series PV data (e.g., daily PV count arrays, tensorized user behavior logs, e.g., 365×N user two-dimensional arrays) and user count data (e.g., access frequency vectors per user ID) as input, and performs anomaly detection, trend prediction, automatic exclusion of spam accesses, etc. For example, AI models such as recurrent neural networks for time-series analysis or autoencoders for anomaly detection may be used. Input examples include daily PV count arrays ([120, 135, 140, . . . ]), access count vectors per user ID ([5, 2, 0, 7, . . . ]), and access logs with user attributes (e.g., {user ID:123, date:2024-06-01, device:smartphone}). Output examples of AI models include aggregated PV count (e.g., total PV=1200), anomaly flags (e.g., spam access detection=1), number of users (e.g., unique users=350), and trend scores (e.g., upward trend=0.85). These outputs are input to subsequent ranking algorithms and used for weighting and scoring. By using AI, it is possible to automatically exclude spam accesses, predict access trends in real time, and improve aggregation accuracy by clustering user behavior, which was difficult with conventional simple counting processes. As a technical effect, the aggregation unit can aggregate large-scale access data in real time and with high accuracy, greatly improving the reliability of rankings and user experience. Application fields include AI recipe sharing platforms, educational AI content distribution, in-company knowledge management, and creative production support services.

The ranking unit may comprise a display unit configured to display rankings based on aggregated data. The display unit may, for example, display rankings based on aggregated data. Rankings may include, for example, display formats of rankings or evaluation criteria, but are not limited thereto. For example, the display unit ranks and displays recipes that have acquired the most PV or have been used by the most users at the top. The display unit may also display rankings as graphs or charts. For example, the display unit displays rankings in a visually easy-to-understand format. By displaying rankings based on aggregated data, users can refer to the rankings. Some or all of the above-described processing in the display unit may be performed using AI or without using AI. For example, the display unit may use an AI model that takes aggregated data as input and outputs rankings to display the rankings. Specifically, the display unit receives ranking data from the ranking unit (e.g., structured tables including recipe ID, PV count, unique user count, user evaluation score, category information, etc.) as input. The display unit implements a graph drawing engine or heat map generation algorithm to visualize the ranking data so that users can intuitively grasp ranking trends and fluctuations. For example, the ranking data can be output in multiple formats such as bar graphs, line graphs, pie charts, and heat maps. When using AI models, the display unit receives time-series arrays of ranking data (e.g., vectors of daily ranking transitions, tensors of ranking distribution by user attribute) as input and automatically selects the optimal display format for each user (e.g., simple display for beginner users, detailed analysis graphs for advanced users). Specific examples of AI models include natural language summary generation by Transformer-based large language models, automatic infographic generation by image generation AI, and ranking grouping by clustering AI. Input examples include ranking data tables (e.g., recipe ID=101, PV=1200, number of users=350, evaluation=4.8), time-series ranking arrays (e.g., ranking transitions [5,3,2,1,1]), and rankings with user attributes (e.g., {user attribute: beginner, recommended display: simple graph}). Output examples of AI models include summary “This week's top recipe is A in the image generation category,” automatically generated graph image files, and customized ranking display layouts for each user. As a subsequent process, the display unit collects users' browsing history and feedback and feeds it back as retraining data for the AI model's display optimization algorithm, thereby achieving continuous improvement in display quality. As a technical effect, the display unit realizes dynamic and personalized ranking visualization that takes into account user attributes, behavior history, and time-series fluctuations, unlike conventional static ranking displays, and brings improvement in user experience, information search efficiency, understanding of ranking data, and optimization of overall system interaction. Application fields include dashboards for AI recipe sharing platforms, educational ranking content distribution, in-company knowledge ranking display, and visualization of achievement rankings for creative production support.

The storage unit may comprise a search unit configured to allow a user to search for recipes. The search unit may, for example, provide functions for users to search for recipes. Searching may include, for example, keyword search or filtering methods, but is not limited thereto. For example, the search unit searches for related recipes based on keywords entered by the user. The search unit may also provide filtering functions, allowing users to narrow down recipes based on specific conditions. For example, the search unit filters search results based on recipe category or evaluation criteria. By allowing users to search for recipes, necessary recipes can be found efficiently. Some or all of the above-described processing in the search unit may be performed using AI or without using AI. For example, the search unit may use an AI model that takes keywords entered by the user as input and outputs related recipes to perform searching. Specifically, the search unit receives multiple parameters as input, such as search queries entered by users (e.g., keywords “image generation,” “summarization,” “high rating,” etc.), category specification (e.g., text generation, image generation, audio generation, etc.), and evaluation score range (e.g., 4.5 or higher). The search unit uses full-text search engines or index structures (e.g., inverted index, B-tree, vector search engine, etc.) to quickly extract relevant recipes from the storage unit's database. When using AI models, the search unit receives natural language search queries (e.g., “image generation prompt for depicting spring landscape”), vectors of users' past search history, and user attribute information as input, and performs semantic similarity calculation (e.g., cosine similarity between embedding vectors), relevance scoring (e.g., BERT-based semantic search AI), and ranking optimization (e.g., search result ranking adjustment by reinforcement learning). Input examples include keyword “summarization,” category “text generation,” evaluation score “4.7 or higher,” and past search history “image generation prompt.” Output examples of AI models include related recipe lists (e.g., recipe ID=201, title=‘High-precision Summarization Prompt,’ evaluation=4.9), ranked search result lists, and personalized recommended recipe sets for each user. As a subsequent process, the search unit collects user search behavior logs and utilizes them for improving AI model search accuracy and retraining recommendation algorithms. As a technical effect, the search unit realizes high-precision and fast recipe search that combines semantic similarity, user behavior history, and multi-condition filtering, unlike conventional simple keyword matching search, and brings reduction in time to reach necessary information, improvement in search experience, and optimization of overall system information search efficiency. Application fields include search functions for AI recipe sharing services, in-company knowledge base search, educational content search, and prompt search for creative production support.

The analysis unit may analyze prompts and work processes using generative AI. Generative AI may be realized by technologies such as natural language generation or image generation. The analysis unit may, for example, analyze the content of prompts and work processes using generative AI. Analysis may include, for example, data analysis methods or analysis objectives, but is not limited thereto. For example, the analysis unit analyzes the content of prompts and work processes using generative AI and extracts information to be saved as recipes. Generative AI may include, for example, text generation AI (e.g., LLM) or image generation AI, but is not limited thereto. For example, the analysis unit uses text generation AI to analyze the content of prompts and generate summaries. The analysis unit may also use image generation AI to generate images based on prompts. By using generative AI, the accuracy of analyzing prompts and work processes is improved. Some or all of the above-described processing in the analysis unit may be performed using AI or without using AI. For example, the analysis unit may use an AI model that takes prompts and work processes as input and outputs analysis results to perform analysis. Specifically, the analysis unit receives prompts entered by users (e.g., “Describe the features of a new product in 100 characters” or “Depict a spring landscape with blue sky and cherry blossoms,” etc. as natural language text) and work processes (e.g., “Summarize with AI model A→Proofread with AI model B” or “Generate with image generation AI→Automatic color correction,” etc. as procedure descriptions) as structured data (JSON format or table format). The analysis unit tokenizes the received prompts, splits them into words or phrases, and converts them into embedding vectors (e.g., 512-dimensional floating-point arrays). For work processes, each step is represented as a time-series tensor (e.g., two-dimensional array of number of steps×feature dimension). The analysis unit inputs these data into AI models such as Transformer-based large language models, convolutional neural networks, or recurrent neural networks. For the text generation category, the AI model classifies the purpose (summarization, translation, creation, etc.) from the prompt and analyzes each step of the work process in a time-series manner. For the image generation category, the prompt is input to the image generation AI (e.g., diffusion model or generative adversarial network) as text embedding+noise vector, and outputs the generated image and its metadata (generation date, model used, parameters, etc.). Examples of AI model input/output include: input: prompt “Describe the features of a new product in 100 characters,” work process “Summarize with AI model A→Proofread with AI model B”→output: summary “This product is a next-generation device that achieves high efficiency and low power consumption.”; or input: prompt “Depict a spring landscape with blue sky and cherry blossoms,” work process “Generate with image generation AI→Automatic color correction”→output: generated image file+metadata, etc. Internally, the analysis unit performs non-conventional processing in high-dimensional space, such as important phrase extraction by Attention mechanism, feature enhancement by self-supervised learning, error minimization by loss functions (e.g., cross-entropy or MSE), and optimization by gradient descent of weight parameters, which is different from conventional simple rule-based human analysis. The analysis results are passed to the subsequent storage unit as structured data and saved as recipe ID, prompt content, work process details, AI model type, generated result samples, metadata, etc. As a technical effect, the analysis unit realizes automatic analysis, classification, and feature extraction of large-scale and diverse prompts and work processes, which is difficult for human work, and brings improvement in analysis accuracy, faster processing speed, automatic removal of noise and redundant information, and overall system efficiency. Application fields include AI utilization education platforms, in-company AI business automation support, creative production support, and research and development knowledge sharing infrastructure.

The storage unit may store analyzed information in a database. The database may include, for example, relational databases or NoSQL databases, but is not limited thereto. The storage unit may, for example, store analyzed information in a database so that users can refer to it later. Storage may include, for example, data formats or storage methods, but is not limited thereto. For example, the storage unit stores analyzed information in a specific format in the database. The storage unit may also provide data backup functions to ensure data safety. For example, the storage unit regularly backs up data to prevent data loss. By storing analyzed information in a database, information management becomes easier. Some or all of the above-described processing in the storage unit may be performed using AI or without using AI. For example, the storage unit may use an AI model that takes analyzed information as input and stores it in a database to perform storage. Specifically, the storage unit receives recipe ID, prompt content, work process details, AI model type, generated result samples, and metadata (creation date, user ID, version number, etc.) from the analysis unit and stores them as structured data (e.g., JSON format, relational tables, document stores, etc.) in the database. During storage, the storage unit automatically performs data normalization (e.g., elimination of duplicate records, ensuring referential integrity), index creation (e.g., for fast search by prompt content or user ID), version management (e.g., management of recipe update history), and access permission management (e.g., setting viewing/editing permissions for each user). As backup functions, the storage unit combines regular snapshot storage, differential backup, and redundant storage in distributed storage to enable rapid recovery in case of data loss or failure. When using AI models, the storage unit receives structured data of analysis results (e.g., recipe ID=101, prompt=“Describe the features of a new product in 100 characters,” work process=“Summarize with AI model A→Proofread with AI model B,” metadata=2024-06-01 12:00, user ID=U001, version=3) as input, and the AI model determines the destination database (e.g., automatic allocation to RDB/NoSQL according to access frequency or data type), optimizes the storage format (e.g., automatic selection of column/document type), and optimizes the storage order (e.g., transaction control considering dependencies). Output examples of AI models include storage completion flag (e.g., storage success=1), destination database name (e.g., main_db), version number (e.g., v3.1), and error log (e.g., duplicate data detected=1). As a subsequent process, stored data is linked in real time to the search unit, ranking unit, and display unit, enabling immediate response to user search, ranking, and viewing requests. As a technical effect, the storage unit realizes automatic normalization, version management, fast search, and secure backup of large-scale and diverse recipe data, which is difficult with manual human storage, and brings efficiency in information management, reduction of data loss risk, and improvement of overall system reliability. Application fields include AI recipe sharing services, in-company knowledge bases, educational content management, and data management infrastructure for creative production support.

The receiving unit may estimate a user's emotion and change the timing of input of prompts and work processes based on the estimated emotion of the user. The receiving unit may, for example, estimate a user's emotion and adjust the timing of input of prompts and work processes based on the estimated emotion. Emotion estimation may be realized using emotion engines or generative AI, for example, by using emotion estimation functions. Generative AI may include text generation AI (e.g., LLM) or multimodal generative AI, but is not limited thereto. For example, the receiving unit may capture the user's facial expression with a camera and estimate emotion using an emotion estimation algorithm. For example, the receiving unit calculates an emotion score based on changes in facial expression. The receiving unit may also record the user's voice and estimate emotion using voice analysis technology. For example, the receiving unit analyzes the tone and speed of the voice and calculates an emotion score. The receiving unit may also collect the user's biometric data (heart rate or skin conductance) with sensors and estimate emotion using an emotion estimation algorithm. For example, the receiving unit calculates an emotion score based on heart rate variability. By adjusting the timing of input according to the user's emotion, the user's burden can be reduced. Some or all of the above-described processing in the receiving unit may be performed using AI or without using AI. For example, the receiving unit may use an AI model that takes the user's emotion data as input and adjusts the timing of input to change the timing of input. Specifically, the receiving unit simultaneously acquires multiple sensor data for emotion estimation (e.g., facial expression tensor from camera images, voice waveform data, heart rate time-series array, skin conductance numerical vector, etc.) and inputs them to a multimodal AI model (e.g., a network integrating image feature extraction CNN, voice feature extraction RNN, and biometric signal MLP). The AI model extracts features for each modality and outputs emotion labels (e.g., joy, anger, anxiety, relaxation, etc.) and emotion scores (e.g., continuous values from 0.0 to 1.0) at the integration layer. Input examples include facial image tensor (224×224×3), voice spectrogram (128×256), heart rate array ([72, 75, 80, . . . ]), skin conductance vector ([0.12, 0.15, 0.10, . . . ]), etc. Output examples of AI models include emotion label “anxiety,” emotion score 0.72, and estimated confidence 0.93. Based on these outputs, the receiving unit dynamically controls the timing of input of prompts and work processes (e.g., immediate input, reminder after several minutes, holding input acceptance for a certain period, etc.). As a subsequent process, the result of timing adjustment is reflected in the user interface, reducing user burden and stress. As a technical effect, the receiving unit automates multimodal emotion estimation and real-time input timing optimization, which is difficult with human subjective judgment, and brings improvement in user experience, reduction of input errors and dropout rate, and optimization of overall system interaction efficiency. Application fields include AI recipe input support, educational AI dialogue systems, stress care input support in medical and welfare fields, and user condition-adaptive interfaces in creative production environments.

The receiving unit may analyze a user's past input history and propose an optimal input method. The receiving unit may, for example, analyze a user's past input history and propose an optimal input method. Input history may include, for example, past input data or the retention period of history, but is not limited thereto. For example, the receiving unit automatically displays prompts and work processes that the user has frequently entered in the past as candidates. The receiving unit may also preferentially propose input methods (voice, text, etc.) that the user has used in the past. For example, the receiving unit predicts and proposes prompts and work processes used at specific times based on the user's past input history. By analyzing a user's past input history, the receiving unit can propose an optimal input method. Some or all of the above-described processing in the receiving unit may be performed using AI or without using AI. For example, the receiving unit may use an AI model that takes a user's past input history as input and outputs an optimal input method to propose input methods. Specifically, the receiving unit extracts past input history data for each user (e.g., time-series list of prompt content, history array of work processes, usage frequency vector of input methods (text/voice/image, etc.), timestamp array of input times, etc.) from the database. The receiving unit inputs these history data to a time-series analysis AI model (e.g., recurrent neural network or time-series clustering algorithm) to extract user input tendencies and patterns. Input examples for the AI model include prompt history list (e.g., “summarization,” “image generation,” “high rating”), work process history (e.g., “summarize with AI model A,” “generate with image generation AI”), input method frequency vector (e.g., [text:80%, voice:15%, image:5%]), and input time distribution (e.g., [9-12:30%, 18-21:50%]). Output examples of the AI model include recommended input method “voice input,” recommended prompt candidates “summarization,” “image generation,” recommended work process “summarize with AI model A→proofread with AI model B,” and recommended input time “18-21.” Based on these outputs, the receiving unit automatically displays candidates and highlights input method switching buttons on the user interface to maximize user input efficiency. As a subsequent process, the adoption rate of proposals and user feedback are collected and used as retraining data for the AI model. As a technical effect, the receiving unit realizes automatic extraction of patterns from large-scale and diverse input histories and automatic proposal of optimal input methods, which is difficult with human memory or simple history reference, and brings efficiency in input work, improvement in user experience, and reduction of input errors and duplicate work. Application fields include AI recipe input support, in-company business automation, educational AI dialogue systems, and input optimization for creative production support.

The receiving unit may perform filtering based on the user's current project or field of interest when inputting prompts and work processes. The receiving unit may, for example, perform filtering based on the user's current project or field of interest when inputting prompts and work processes. Filtering may include, for example, filter conditions or application methods, but is not limited thereto. For example, the receiving unit preferentially displays prompts and work processes related to the user's ongoing project. The receiving unit may also propose highly relevant prompts and work processes based on the user's field of interest. For example, the receiving unit refers to the user's past project history to filter and propose optimal prompts and work processes. By performing filtering based on the user's current project or field of interest, highly relevant information can be provided. Some or all of the above-described processing in the receiving unit may be performed using AI or without using AI. For example, the receiving unit may use an AI model that takes the user's current project or field of interest as input and outputs filtering results to perform filtering. Specifically, the receiving unit obtains the user's current project information (e.g., project ID, progress status, category), field of interest (e.g., natural language processing, image generation, summarization, creative production, etc.), and past project history (e.g., project ID list, category distribution, achievement score, etc.) from the database. The receiving unit vectorizes these information and inputs them to a filtering AI model (e.g., BERT-based model for semantic similarity calculation or clustering AI). Input examples for the AI model include project category vector (e.g., [NLP:1, image generation:0, summarization:1]), field of interest vector (e.g., [summarization:0.9, image generation:0.7]), and history distribution (e.g., [Project A:3 times, Project B:1 time]). Output examples of the AI model include recommended prompt list (e.g., “summarization prompt,” “image generation prompt”), recommended work process list (e.g., “summarize with AI model A→proofread with AI model B”), and filtering score (e.g., 0.85). Based on these outputs, the receiving unit preferentially displays highly relevant prompts and work processes on the user interface to optimize user choices. As a subsequent process, the adoption rate of filtering results and user feedback are collected and used for retraining the AI model. As a technical effect, the receiving unit automates high-precision filtering based on multidimensional feature quantities, which is difficult with human subjective judgment or simple category matching, and brings improvement in information search efficiency, optimization of user experience, and efficiency in providing highly relevant information. Application fields include AI recipe input support, in-company project management, educational AI content selection, and prompt optimization for creative production support.

The receiving unit may estimate a user's emotion and determine the priority of prompts and work processes to be input based on the estimated emotion of the user. The receiving unit may, for example, estimate a user's emotion and determine the priority of prompts and work processes to be input based on the estimated emotion. Emotion estimation may be realized using emotion engines or generative AI, for example, by using emotion estimation functions. Generative AI may include text generation AI (e.g., LLM) or multimodal generative AI, but is not limited thereto. For example, the receiving unit may capture the user's facial expression with a camera and estimate emotion using an emotion estimation algorithm. For example, the receiving unit calculates an emotion score based on changes in facial expression. The receiving unit may also record the user's voice and estimate emotion using voice analysis technology. For example, the receiving unit analyzes the tone and speed of the voice and calculates an emotion score. The receiving unit may also collect the user's biometric data (heart rate or skin conductance) with sensors and estimate emotion using an emotion estimation algorithm. For example, the receiving unit calculates an emotion score based on heart rate variability. By determining the priority of prompts and work processes to be input according to the user's emotion, efficient input becomes possible. Some or all of the above-described processing in the receiving unit may be performed using AI or without using AI. For example, the receiving unit may use an AI model that takes the user's emotion data as input and determines the priority of prompts and work processes to be input. Specifically, the receiving unit simultaneously acquires multiple sensor data for emotion estimation (e.g., facial expression image tensor, voice waveform, heart rate time-series, skin conductance vector, etc.) and inputs them to a multimodal AI model (e.g., CNN+RNN+MLP integrated network). The AI model extracts features for each modality and outputs emotion labels (e.g., joy, anger, anxiety, relaxation, etc.) and emotion scores (e.g., 0.0 to 1.0) at the integration layer. Input examples include facial image tensor (224×224×3), voice spectrogram (128×256), heart rate array ([72, 75, 80, . . . ]), skin conductance vector ([0.12, 0.15, 0.10, . . . ]), etc. Output examples of AI models include emotion label “anxiety,” emotion score 0.72, and estimated confidence 0.93. Based on these outputs, the receiving unit dynamically determines the priority of prompts and work processes (e.g., prioritize simple prompts when stress is high, prioritize complex work processes when relaxed, etc.). As a subsequent process, the result of priority determination is reflected in the user interface, improving user input efficiency and satisfaction. As a technical effect, the receiving unit automates multimodal emotion estimation and real-time input priority optimization, which is difficult with human subjective judgment, and brings improvement in user experience, reduction of input errors and dropout rate, and optimization of overall system interaction efficiency. Application fields include AI recipe input support, educational AI dialogue systems, stress care input support in medical and welfare fields, and user condition-adaptive interfaces in creative production environments.

The receiving unit may prioritize the input of highly relevant information based on the user's geographic location information when inputting prompts and work processes. The receiving unit may, for example, consider the user's geographic location information when inputting prompts and work processes to prioritize highly relevant information. Geographic location information may include, for example, GPS data or location information services, but is not limited thereto. For example, the receiving unit preferentially displays prompts and work processes related to the region when the user is in a specific area. The receiving unit may also propose optimal prompts and work processes based on the user's current location. For example, the receiving unit refers to the user's geographic location information to filter highly relevant prompts and work processes. By considering the user's geographic location information, highly relevant information can be provided. Some or all of the above-described processing in the receiving unit may be performed using AI or without using AI. For example, the receiving unit may use an AI model that takes the user's geographic location information as input and outputs highly relevant information to prioritize information input. Specifically, the receiving unit integrates multiple sources of geographic location information, such as GPS coordinate data (e.g., latitude/longitude floating-point pairs) obtained from the user device, region names or landmark IDs obtained from location information service APIs, and indoor location estimation data from Wi-Fi/Bluetooth beacons. The receiving unit structures these geographic location information as feature vectors (e.g., 10-dimensional vectors including latitude, longitude, altitude, region category, time, etc.) and inputs them to a filtering AI model (e.g., K-means algorithm for geographic clustering or BERT-based model for semantic similarity calculation). Input examples for the AI model include GPS coordinates (35.6895, 139.6917), region category “urban area,” time “2024-06-01 14:00,” etc. Output examples include prompt lists with relevance scores (e.g., “urban event summarization prompt” score 0.92, “local tourism image generation prompt” score 0.45), recommended work process lists (e.g., “local photo shooting→correction with image generation AI”). Based on these outputs, the receiving unit preferentially displays region-optimized prompts and work processes on the user interface to dynamically optimize user choices. As a subsequent process, selection history and user feedback based on geographic location information are collected and used as retraining data for the AI model. As a technical effect, the receiving unit automates high-precision information filtering based on multidimensional geographic information, which is difficult with human subjective judgment or simple region name matching, and realizes aggregation of region-specific AI utilization know-how, optimization of user experience, improvement of information search efficiency, and personalized information provision for the entire system. Application fields include region-specific AI recipe sharing services, tourism and regional promotion support, prompt proposals for on-site response during disasters, region-specific AI content distribution for education, and location-based AI support for creative production environments.

The receiving unit may input relevant information based on the user's social media activity when inputting prompts and work processes. The receiving unit may, for example, analyze the user's social media activity when inputting prompts and work processes and input relevant information. Social media activity may include, for example, post content or number of likes, but is not limited thereto. For example, the receiving unit proposes prompts and work processes related to information shared by the user on social media. The receiving unit may also display prompts and work processes related to topics of interest based on the user's social media activity. For example, the receiving unit proposes prompts and work processes used by the user's followers or friends on social media. By analyzing the user's social media activity, relevant information can be provided. Some or all of the above-described processing in the receiving unit may be performed using AI or without using AI. For example, the receiving unit may use an AI model that takes the user's social media activity as input and outputs relevant information to input information. Specifically, the receiving unit structures diverse data obtained from social media APIs linked by the user, such as post data (e.g., text posts, image posts, video links), engagement metrics (e.g., number of likes, shares, comments), and follower attributes (e.g., interest tags, region, age group). The receiving unit inputs these data to a multimodal AI model combining natural language processing AI models (e.g., Transformer-based large language models), image feature extraction CNN, and graph neural networks. Input examples include post text “AI-based image generation is interesting,” image post (224×224×3 tensor), number of likes 120, follower interest tags “creative,” “summarization,” etc. The AI model outputs topic classification from post content (e.g., “image generation” score 0.88, “summarization” score 0.65), engagement score (e.g., high interest=0.91), and trending prompt list in the network (e.g., “image generation prompt A”). Based on these outputs, the receiving unit preferentially displays prompts and work processes optimized for the user's interests and network trends on the user interface to dynamically optimize user choices. As a subsequent process, selection history and user feedback based on social media activity are collected and used as retraining data for the AI model. As a technical effect, the receiving unit automates high-precision information recommendation based on large-scale and diverse social graph information, which is difficult with manual human work or simple keyword matching, and realizes improvement in trend-following, optimization of user experience, diffusion of AI utilization know-how through network effects, and improvement of information search efficiency for the entire system. Application fields include SNS integration for AI recipe sharing services, trend recommendation for educational AI content, social analysis for in-company knowledge sharing, and network-based prompt proposals for creative production support.

The analysis unit may estimate a user's emotion and adjust the method of expression of analysis based on the estimated emotion of the user. The analysis unit may, for example, estimate a user's emotion and adjust the method of expression of analysis based on the estimated emotion. Emotion estimation may be realized using emotion engines or generative AI, for example, by using emotion estimation functions. Generative AI may include text generation AI (e.g., LLM) or multimodal generative AI, but is not limited thereto. For example, the analysis unit may capture the user's facial expression with a camera and estimate emotion using an emotion estimation algorithm. For example, the analysis unit calculates an emotion score based on changes in facial expression. The analysis unit may also record the user's voice and estimate emotion using voice analysis technology. For example, the analysis unit analyzes the tone and speed of the voice and calculates an emotion score. The analysis unit may also collect the user's biometric data (heart rate or skin conductance) with sensors and estimate emotion using an emotion estimation algorithm. For example, the analysis unit calculates an emotion score based on heart rate variability. By adjusting the method of expression of analysis according to the user's emotion, analysis results that are easy for the user to understand can be provided. Some or all of the above-described processing in the analysis unit may be performed using AI or without using AI. For example, the analysis unit may use an AI model that takes the user's emotion data as input and adjusts the method of expression of analysis. Specifically, the analysis unit simultaneously acquires multiple sensor data for emotion estimation (e.g., facial expression image tensor (224×224×3), voice waveform data, heart rate time-series array, skin conductance vector, etc.) and inputs them to a multimodal AI model (e.g., CNN+RNN+MLP integrated network). The AI model extracts features for each modality and outputs emotion labels (e.g., joy, anger, anxiety, relaxation, etc.) and emotion scores (e.g., continuous values from 0.0 to 1.0) at the integration layer. Input examples include facial image tensor (224×224×3), voice spectrogram (128×256), heart rate array ([72, 75, 80, . . . ]), skin conductance vector ([0.12, 0.15, 0.10, . . . ]), etc. Output examples of AI models include emotion label “anxiety,” emotion score 0.72, and estimated confidence 0.93. Based on these outputs, the analysis unit dynamically determines the method of expression of analysis results (e.g., concise summary display, detailed segmented display, emphasis on positive expressions, addition of cautionary messages, etc.). For example, if the user is anxious, the analysis result is summarized in plain language and expressions that provide reassurance are selected. If the user is relaxed, detailed analysis results and technical background are displayed. As a subsequent process, selection history of expression methods and user feedback are collected and used as retraining data for the AI model. As a technical effect, the analysis unit automates multimodal emotion estimation and real-time optimization of analysis expression, which is difficult with human subjective judgment, and brings improvement in user experience, understanding of analysis results, stress reduction, and optimization of overall system interaction efficiency. Application fields include AI recipe analysis support, educational AI dialogue systems, stress care analysis support in medical and welfare fields, and user condition-adaptive analysis interfaces in creative production environments.

The analysis unit may change the level of detail of analysis based on the importance of prompts and work processes. The analysis unit may, for example, adjust the level of detail of analysis based on the importance of prompts and work processes. Importance may include, for example, impact or priority, but is not limited thereto. For example, the analysis unit performs detailed analysis for prompts and work processes with high importance. The analysis unit may also perform concise analysis for prompts and work processes with low importance. For example, the analysis unit dynamically adjusts the level of detail of analysis according to the importance of prompts and work processes. By adjusting the level of detail of analysis based on the importance of prompts and work processes, efficient analysis becomes possible. Some or all of the above-described processing in the analysis unit may be performed using AI or without using AI. For example, the analysis unit may use an AI model that takes the importance of prompts and work processes as input and outputs the level of detail of analysis to adjust the level of detail. Specifically, the analysis unit applies importance scoring algorithms (e.g., TF-IDF, Attention weighting, user-specified priority labels, etc.) to prompts and work processes entered by users, and calculates importance scores for each prompt and work process (e.g., continuous values from 0.0 to 1.0 or categories such as High/Medium/Low). The analysis unit inputs these importance scores to an analysis detail control AI model (e.g., Transformer-based large language model or hierarchical Attention network). Input examples for the AI model include prompt “Describe the features of a new product in 100 characters” (importance 0.95), work process “Summarize with AI model A→Proofread with AI model B” (importance 0.90), prompt “Simple prompt for image generation” (importance 0.45), etc. The AI model outputs detailed analysis instructions (e.g., detailed analysis=1, simple analysis=0), number of analysis steps (e.g., 5 steps for detailed analysis, 2 steps for simple analysis), and amount of output information (e.g., full summary+evidence extraction+risk analysis for detailed, summary only for simple). The analysis unit applies multi-stage analysis by natural language processing AI (e.g., intent extraction→structuring→risk evaluation→related knowledge addition→summary generation) for prompts and work processes with high importance, and performs only summarization or keyword extraction for those with low importance. Internally, the AI model performs emphasis of important phrases by Attention mechanism, optimization of analysis accuracy by loss functions, and dynamic adjustment of weight parameters. Output examples of AI models include detailed analysis result “This product is a next-generation device that achieves high efficiency and low power consumption. Evidence: new circuit design, Risk: possibility of increased cost” and simple analysis result “Image generation prompt: spring landscape.” As a subsequent process, selection history of analysis detail and user feedback are collected and used as retraining data for the AI model. As a technical effect, the analysis unit automates optimal allocation of analysis resources according to importance, which is difficult with human subjective judgment or uniform processing, and realizes improvement in overall system computational efficiency, optimization of analysis accuracy, improvement in user experience, and suppression of resource consumption. Application fields include AI recipe analysis support, in-company business automation, educational AI content analysis, and prompt analysis optimization for creative production support.

The analysis unit may apply different analysis algorithms according to the category of prompts and work processes during analysis. The analysis unit may, for example, apply different analysis algorithms according to the category of prompts and work processes. Categories may include, for example, genre or type, but are not limited thereto. For example, the analysis unit applies natural language processing algorithms to prompts for text generation. The analysis unit may also apply image processing algorithms to prompts for image generation. For example, the analysis unit applies audio processing algorithms to prompts for audio generation. By applying different analysis algorithms according to the category of prompts and work processes, analysis accuracy is improved. Some or all of the above-described processing in the analysis unit may be performed using AI or without using AI. For example, the analysis unit may use an AI model that takes the category of prompts and work processes as input and outputs analysis algorithms to perform analysis. Specifically, the analysis unit applies category classification algorithms (e.g., BERT-based text classification AI, image feature extraction CNN, audio spectrum classification RNN, etc.) to prompts and work processes entered by users, and automatically determines the category of each prompt and work process (e.g., text generation, image generation, audio generation, summarization, translation, creative production, etc.). Based on the category determination result, the analysis unit inputs it to an analysis algorithm selection AI model (e.g., rule-based selector+reinforcement learning algorithm) to determine the optimal analysis algorithm (e.g., Transformer for natural language processing, diffusion model for image generation, WaveNet for audio synthesis, etc.). Input examples for the AI model include prompt “Describe the features of a new product in 100 characters” (category: text generation), prompt “Depict a spring landscape with blue sky and cherry blossoms” (category: image generation), prompt “Generate greeting audio” (category: audio generation), etc. The AI model outputs analysis algorithm ID (e.g., NLP-Transformer, IMG-Diffusion, AUDIO-WaveNet), parameter set (e.g., token length 512, image resolution 512×512, audio length 3 seconds), etc. The analysis unit calls the optimal AI model for each prompt and work process according to the selected analysis algorithm and executes analysis. Examples of AI model input/output include: text generation category: input “summarization prompt”→output “summary text”; image generation category: input “image generation prompt+noise vector”→output “generated image file”; audio generation category: input “audio generation prompt+phoneme sequence”→output “synthesized audio file.” As a subsequent process, selection history of analysis algorithms and evaluation of analysis accuracy are collected and used as retraining data for the AI model. As a technical effect, the analysis unit automates optimal algorithm selection for each category, which is difficult with manual human work or uniform processing, and realizes improvement in analysis accuracy, optimization of computational efficiency, improvement in overall system flexibility, and optimization of user experience. Application fields include AI recipe analysis support, in-company business automation, educational AI content analysis, and multimodal analysis optimization for creative production support.

The analysis unit may estimate a user's emotion and adjust the length of analysis based on the estimated emotion of the user. The analysis unit may, for example, estimate a user's emotion and adjust the length of analysis based on the estimated emotion. Emotion estimation may be realized using emotion engines or generative AI, for example, by using emotion estimation functions. Generative AI may include text generation AI (e.g., LLM) or multimodal generative AI, but is not limited thereto. For example, the analysis unit may capture the user's facial expression with a camera and estimate emotion using an emotion estimation algorithm. For example, the analysis unit calculates an emotion score based on changes in facial expression. The analysis unit may also record the user's voice and estimate emotion using voice analysis technology. For example, the analysis unit analyzes the tone and speed of the voice and calculates an emotion score. The analysis unit may also collect the user's biometric data (heart rate or skin conductance) with sensors and estimate emotion using an emotion estimation algorithm. For example, the analysis unit calculates an emotion score based on heart rate variability. By adjusting the length of analysis according to the user's emotion, the analysis unit can provide optimal analysis results for the user. Some or all of the above-described processing in the analysis unit may be performed using AI or without using AI. For example, the analysis unit may use an AI model that takes the user's emotion data as input and adjusts the length of analysis. Specifically, the analysis unit simultaneously acquires multiple sensor data for emotion estimation (e.g., facial expression image tensor (224×224×3), voice waveform data, heart rate time-series array, skin conductance vector, etc.) and inputs them to a multimodal AI model (e.g., CNN+RNN+MLP integrated network). The AI model extracts features for each modality and outputs emotion labels (e.g., joy, anger, anxiety, relaxation, etc.) and emotion scores (e.g., continuous values from 0.0 to 1.0) at the integration layer. Input examples include facial image tensor (224×224×3), voice spectrogram (128×256), heart rate array ([72, 75, 80, . . . ]), skin conductance vector ([0.12, 0.15, 0.10, . . . ]), etc. Output examples of AI models include emotion label “anxiety,” emotion score 0.72, and estimated confidence 0.93. Based on these outputs, the analysis unit dynamically determines the length of analysis results (e.g., concise summary display, detailed segmented display, summary with quantity adjustment, etc.). For example, if the user is anxious, the analysis result is summarized briefly and expressed in an easy-to-understand manner. If the user is relaxed, detailed analysis results and technical background are displayed. Output examples of AI models include concise display “Summary: This product is a next-generation device that achieves high efficiency and low power consumption,” and detailed display “Summary+evidence+risk analysis+related knowledge.” As a subsequent process, selection history of analysis length and user feedback are collected and used as retraining data for the AI model. As a technical effect, the analysis unit automates multimodal emotion estimation and real-time optimization of analysis length, which is difficult with human subjective judgment, and brings improvement in user experience, understanding of analysis results, stress reduction, and optimization of overall system interaction efficiency. Application fields include AI recipe analysis support, educational AI dialogue systems, stress care analysis support in medical and welfare fields, and user condition-adaptive analysis interfaces in creative production environments.

The analysis unit may set the priority of analysis based on the submission timing of prompts and work processes. The analysis unit may, for example, determine the priority of analysis based on the submission timing of prompts and work processes. Submission timing may include, for example, submission date or submission time, but is not limited thereto. For example, the analysis unit prioritizes analysis of prompts and work processes submitted earlier. The analysis unit may also postpone analysis of prompts and work processes submitted later. For example, the analysis unit dynamically adjusts the priority of analysis based on submission timing. By determining the priority of analysis based on submission timing of prompts and work processes, efficient analysis becomes possible. Some or all of the above-described processing in the analysis unit may be performed using AI or without using AI. For example, the analysis unit may use an AI model that takes submission timing of prompts and work processes as input and outputs priority to determine the priority of analysis. Specifically, the analysis unit extracts submission time information (e.g., UNIX timestamp, ISO8601 date-time, submission order index, etc.) of prompts and work processes received from the receiving unit from the database and structures it as a submission timing vector (e.g., submission date-time, elapsed time, batch ID, etc.). The analysis unit inputs these submission timing information to a priority determination AI model (e.g., recurrent neural network for time-series analysis or weighted priority scoring algorithm). Input examples for the AI model include prompt A (submission date-time 2024-06-01 10:00), prompt B (submission date-time 2024-06-01 12:00), prompt C (submission date-time 2024-06-01 09:30), etc. The AI model outputs priority list (e.g., C→A→B), priority scores (e.g., C=0.95, A=0.90, B=0.85), etc. The analysis unit controls the analysis job scheduler according to the priority list and executes analysis in order from prompts and work processes submitted earlier. Internally, the AI model performs weighting of submission timing, batch processing optimization, and resource allocation control. Output examples of AI models include priority “Prompt C→Prompt A→Prompt B,” priority scores “0.95, 0.90, 0.85,” etc. As a subsequent process, history of priority determination and statistics of analysis waiting time are collected and used as retraining data for the AI model. As a technical effect, the analysis unit automates optimization of analysis priority based on submission timing, which is difficult with manual human work or simple FIFO processing, and realizes improvement in overall system throughput, reduction of waiting time, optimization of resource utilization, and improvement in user experience. Application fields include AI recipe analysis support, in-company business automation, educational AI content analysis, and job scheduling optimization for creative production support.

The analysis unit may adjust the order of analysis based on the relevance of prompts and work processes during analysis. The analysis unit may, for example, adjust the order of analysis based on the relevance of prompts and work processes. Relevance may include, for example, relevance scores or co-occurrence frequency, but is not limited thereto. For example, the analysis unit prioritizes analysis of prompts and work processes with high relevance. The analysis unit may also postpone analysis of prompts and work processes with low relevance. For example, the analysis unit dynamically adjusts the order of analysis based on the relevance of prompts and work processes. By adjusting the order of analysis based on the relevance of prompts and work processes, efficient analysis becomes possible. Some or all of the above-described processing in the analysis unit may be performed using AI or without using AI. For example, the analysis unit may use an AI model that takes the relevance of prompts and work processes as input and outputs the order of analysis to adjust the order. Specifically, the analysis unit uses semantic similarity calculation AI models (e.g., BERT-based embedding vector generation models or co-occurrence frequency analysis algorithms) to calculate relevance among multiple prompts and work processes. The analysis unit generates feature vectors (e.g., 512-dimensional embedding vectors) for each prompt and work process and calculates relevance scores (e.g., 0.0 to 1.0) using indicators such as cosine similarity or Jaccard coefficient. Input examples include prompt A “summarization prompt,” work process A “summarize with AI model A,” prompt B “image generation prompt,” work process B “generate with image generation AI,” etc. The AI model outputs relevance score matrices (e.g., A−B=0.85, A−A=1.0, B−B=1.0, A−B=0.45), analysis order lists (e.g., A→B), etc. The analysis unit prioritizes analysis of combinations of prompts and work processes with high relevance and postpones those with low relevance. Internally, the AI model performs clustering algorithms, graph-based order optimization, batch processing optimization, etc. Output examples of AI models include analysis order “A→B,” relevance clusters “summarization group,” “image generation group,” etc. As a subsequent process, history of analysis order determination and evaluation of analysis efficiency are collected and used as retraining data for the AI model. As a technical effect, the analysis unit automates optimization of analysis order based on relevance, which is difficult with human subjective judgment or simple ordering, and realizes improvement in overall system analysis efficiency, optimization of resource utilization, and improvement in user experience. Application fields include AI recipe analysis support, in-company business automation, educational AI content analysis, and optimization of analysis order for creative production support.

The storage unit can estimate a user's emotion and determine the priority of recipes to be stored based on the estimated emotion of the user. For example, the storage unit estimates the user's emotion and determines the priority of recipes to be stored based on the estimated emotion. Emotion estimation may be realized using an emotion engine or generative AI, such as an emotion estimation function. Generative AI may include text generation AI (for example, LLM) or multimodal generative AI, but is not limited thereto. For example, the storage unit may capture the user's facial expression with a camera and estimate the emotion using an emotion estimation algorithm. For example, the storage unit may calculate an emotion score based on changes in facial expression. The storage unit may also record the user's voice and estimate the emotion using voice analysis technology. For example, the storage unit may analyze the tone and speed of the voice and calculate an emotion score. The storage unit may also collect the user's biometric data (heart rate or skin conductance) with a sensor and estimate the emotion using an emotion estimation algorithm. For example, the storage unit may calculate an emotion score based on heart rate variability. By determining the priority of recipes to be stored according to the user's emotion, efficient storage can be achieved. Some or all of the above-described processing in the storage unit may be performed using AI or without using AI. For example, the storage unit may use an AI model that takes the user's emotion data as input and determines the priority of recipes to be stored. Specifically, the storage unit simultaneously acquires multiple sensor data for emotion estimation (e.g., facial expression image tensor (224×224×3), voice waveform data, heart rate time series array, skin conductance vector, etc.) and inputs them into a multimodal AI model (e.g., a network integrating image feature extraction CNN, voice feature extraction RNN, and MLP for biosignals). The storage unit extracts features for each modality and outputs emotion labels (e.g., joy, anger, anxiety, relaxation, etc.) and emotion scores (e.g., continuous values from 0.0 to 1.0) in the integration layer. Examples of input include facial image tensor (224×224×3), voice spectrogram (128×256), heart rate array ([72, 75, 80, . . . ]), skin conductance vector ([0.12, 0.15, 0.10, . . . ]), etc. Examples of AI model output include emotion label “anxiety”, emotion score 0.72, and estimated confidence 0.93. Based on these outputs, the storage unit dynamically determines the priority of recipes waiting to be stored (e.g., prioritizing simple recipes when stress is high, prioritizing complex recipes when relaxed, etc.). The storage unit implements a weighted scoring algorithm that combines emotion scores and recipe attributes (e.g., workload, importance, urgency, etc.) as the priority determination algorithm, and optimizes the order of the storage queue. Internally, the AI model performs emphasis of important features using attention mechanisms, optimization of estimation accuracy using loss functions, and dynamic adjustment of weight parameters. Examples of AI model output include a storage priority list (e.g., Recipe A→Recipe C→Recipe B), priority scores (e.g., A=0.95, C=0.90, B=0.85), etc. In subsequent processing, the storage unit collects statistics on storage priority determination history and waiting times, and utilizes them as retraining data for the AI model. As a technical effect, the storage unit automates optimization of storage priority based on emotional state, which is difficult with human subjective judgment or simple FIFO processing, thereby improving overall system storage efficiency, reducing waiting times, enhancing user experience, and optimizing resource utilization. Application fields include emotion-adaptive storage management for AI recipe sharing services, stress care storage support for educational AI content, user state-adaptive data storage in medical and welfare fields, and emotion-linked recipe storage optimization for creative production support.

The storage unit can improve the accuracy of storage at the time of saving by considering the interrelationship between prompts and work processes. For example, the storage unit improves the accuracy of storage by considering the interrelationship between prompts and work processes. The interrelationship may include, for example, relevance or dependency, but is not limited thereto. For example, the storage unit analyzes the relevance between prompts and work processes and proposes an optimal storage method. The storage unit may also improve the accuracy of storage by considering the interrelationship between prompts and work processes. For example, the storage unit adjusts the order of storage based on the interrelationship between prompts and work processes. By considering the interrelationship between prompts and work processes, the accuracy of storage is improved. Some or all of the above-described processing in the storage unit may be performed using AI or without using AI. For example, the storage unit may use an AI model that takes the interrelationship between prompts and work processes as input and outputs a storage method to improve storage accuracy. Specifically, the storage unit uses a semantic similarity calculation AI model (e.g., BERT-based embedding vector generation model or co-occurrence frequency analysis algorithm) to quantitatively evaluate the relevance between prompts and work processes. The storage unit generates feature vectors for each prompt and work process (e.g., 512-dimensional embedding vectors) and calculates relevance scores (e.g., 0.0 to 1.0) and dependency graphs using indicators such as cosine similarity or Jaccard coefficient. Examples of input include prompt “summary prompt”, work process “summarize with AI model A”, prompt “image generation prompt”, work process “generate with image generation AI”, etc. The AI model outputs, for example, a relevance score matrix (e.g., summary prompt-summary process=0.92, image generation prompt-image generation process=0.88), dependency graph (e.g., prompt A→work process A), etc. Based on the relevance scores and dependency graphs, the storage unit dynamically optimizes the storage order (e.g., consecutively storing prompts and work processes with dependencies), storage format (e.g., grouping related recipes for storage), and storage metadata (e.g., assigning relevance scores). Internally, the AI model performs emphasis of important features using attention mechanisms, optimization of relevance estimation accuracy using loss functions, and dynamic adjustment of weight parameters. Examples of AI model output include a storage order list (e.g., summary type→image generation type), storage group ID (e.g., Group A=summary related, Group B=image generation related), etc. In subsequent processing, the storage unit collects history of improved storage accuracy and user feedback, and utilizes them as retraining data for the AI model. As a technical effect, the storage unit automates optimization of storage accuracy based on the interrelationship between prompts and work processes, which is difficult with human subjective judgment or simple uniform storage, thereby improving information consistency, searchability and reusability, and overall system data quality. Application fields include related recipe group storage for AI recipe sharing services, dependency management in enterprise knowledge bases, relevance-based storage for educational AI content, and process-linked storage optimization for creative production support.

The storage unit can perform storage at the time of saving based on attribute information of the submitter of prompts and work processes. For example, the storage unit performs storage by considering the attribute information of the submitter of prompts and work processes. Attribute information may include, for example, age, gender, occupation, etc., but is not limited thereto. For example, the storage unit proposes an optimal storage method based on the submitter's field of expertise. The storage unit may also improve the accuracy of storage based on the submitter's years of experience. For example, the storage unit adjusts the order of storage by considering the attribute information of the submitter. By considering the attribute information of the submitter, the accuracy of storage is improved. Some or all of the above-described processing in the storage unit may be performed using AI or without using AI. For example, the storage unit may use an AI model that takes the attribute information of the submitter as input and outputs a storage method to perform storage. Specifically, the storage unit obtains attribute information of the submitter (e.g., age, gender, occupation, field of expertise, years of experience, affiliated organization, user ID, etc.) from a database and structures it as feature vectors (e.g., age=35, gender=1, occupation=2, field of expertise=natural language processing, years of experience=7 years, etc.). The storage unit inputs the attribute information vector into a storage optimization AI model (e.g., MLP for attribute clustering, decision tree, reinforcement learning algorithm, etc.) and dynamically determines the storage format (e.g., categorization by field of expertise, assignment of storage priority according to years of experience), storage order (e.g., prioritizing storage of expert recipes), and storage metadata (e.g., assignment of attribute tags). Examples of input include attribute vector (age=28, occupation=engineer, field of expertise=image generation, years of experience=3 years), prompt “image generation prompt”, work process “generate with image generation AI”, etc. Examples of AI model output include storage category “image generation”, storage priority 0.92, attribute tag “engineer·3 years”, etc. Based on these outputs, the storage unit executes categorization of the storage database and optimization of storage order. Internally, the AI model performs weighting of attribute features, clustering, and optimization of storage efficiency. In subsequent processing, the storage unit collects storage history and user feedback and utilizes them as retraining data for the AI model. As a technical effect, the storage unit automates optimization of storage based on multidimensional attribute information, which is difficult with human subjective judgment or simple attribute matching, thereby achieving personalization of information, improved searchability and reusability, and overall system data quality improvement. Application fields include attribute-linked storage for AI recipe sharing services, field-specific storage in enterprise knowledge bases, attribute-optimized storage for educational AI content, and user attribute-adaptive storage for creative production support.

The storage unit can estimate a user's emotion and adjust the display method of recipes to be stored based on the estimated emotion of the user. For example, the storage unit estimates the user's emotion and adjusts the display method of recipes to be stored based on the estimated emotion. Emotion estimation may be realized using an emotion engine or generative AI, such as an emotion estimation function. Generative AI may include text generation AI (for example, LLM) or multimodal generative AI, but is not limited thereto. For example, the storage unit may capture the user's facial expression with a camera and estimate the emotion using an emotion estimation algorithm. For example, the storage unit may calculate an emotion score based on changes in facial expression. The storage unit may also record the user's voice and estimate the emotion using voice analysis technology. For example, the storage unit may analyze the tone and speed of the voice and calculate an emotion score. The storage unit may also collect the user's biometric data (heart rate or skin conductance) with a sensor and estimate the emotion using an emotion estimation algorithm. For example, the storage unit may calculate an emotion score based on heart rate variability. By adjusting the display method according to the user's emotion, the display can be made easier for the user to view. Some or all of the above-described processing in the storage unit may be performed using AI or without using AI. For example, the storage unit may use an AI model that takes the user's emotion data as input and adjusts the display method of recipes to be stored. Specifically, the storage unit simultaneously acquires multiple sensor data for emotion estimation (e.g., facial expression image tensor (224×224×3), voice waveform data, heart rate time series array, skin conductance vector, etc.) and inputs them into a multimodal AI model (e.g., CNN+RNN+MLP integrated network). The storage unit extracts features for each modality and outputs emotion labels (e.g., joy, anger, anxiety, relaxation, etc.) and emotion scores (e.g., continuous values from 0.0 to 1.0) in the integration layer. Examples of input include facial image tensor (224×224×3), voice spectrogram (128×256), heart rate array ([72, 75, 80, . . . ]), skin conductance vector ([0.12, 0.15, 0.10, . . . ]), etc. Examples of AI model output include emotion label “relaxation”, emotion score 0.85, and estimated confidence 0.95. Based on these outputs, the storage unit dynamically determines the display method of recipes (e.g., concise summary display, detailed segmented display, emphasis on positive expressions, addition of warning messages, dynamic changes in color and layout, etc.). For example, when the user is anxious, the recipe display is summarized in plain language and expressions or colors that provide reassurance are selected. When the user is relaxed, detailed recipe content and technical background are displayed. Examples of AI model output include concise display “Summary: This recipe is a highly efficient image generation procedure.”, detailed display “Procedure+rationale+precautions+related knowledge”, etc. In subsequent processing, the storage unit collects selection history of display methods and user feedback and utilizes them as retraining data for the AI model. As a technical effect, the storage unit automates multimodal emotion estimation and real-time optimization of display methods, which is difficult with human subjective judgment, thereby improving user experience, understanding of recipe content, reducing stress, and enhancing overall system interaction efficiency. Application fields include AI recipe storage and display support, emotion-adaptive display for educational AI content, stress care recipe display in medical and welfare fields, and user condition-adaptive recipe interfaces for creative production sites.

The storage unit can perform storage at the time of saving by considering the geographic distribution of prompts and work processes. For example, the storage unit performs storage by considering the geographic distribution of prompts and work processes. Geographic distribution may include, for example, region-specific data or map display, but is not limited thereto. For example, the storage unit prioritizes storage of prompts and work processes related to geographically close locations. The storage unit may also propose an optimal storage method based on geographic distribution. For example, the storage unit adjusts the order of storage by considering geographic distribution. By considering geographic distribution, highly relevant information can be stored. Some or all of the above-described processing in the storage unit may be performed using AI or without using AI. For example, the storage unit may use an AI model that takes the geographic distribution of prompts and work processes as input and outputs a storage method to perform storage. Specifically, the storage unit obtains geographic location information associated with prompts and work processes (e.g., GPS coordinates, region name, landmark ID, indoor location estimation data via Wi-Fi/Bluetooth beacons, etc.) and structures them as feature vectors (e.g., 10-dimensional vectors including latitude, longitude, altitude, region category, time, etc.). The storage unit inputs the geographic distribution vector into a geographic clustering AI model (e.g., K-means algorithm or BERT-based model for semantic similarity calculation) and dynamically determines storage groups (e.g., region-specific clusters), storage priority (e.g., prioritizing local recipes), and storage metadata (e.g., assignment of region tags). Examples of input include GPS coordinates (35.6895, 139.6917), region category “urban area”, time “2024-06-01 14:00”, etc. Examples of AI model output include storage group ID “urban area”, storage priority 0.93, region tag “Tokyo”, etc. Based on these outputs, the storage unit executes region-based partitioning of the storage database and optimization of storage order. Internally, the AI model performs weighting of geographic features, clustering, and optimization of storage efficiency. In subsequent processing, the storage unit collects storage history and user feedback and utilizes them as retraining data for the AI model. As a technical effect, the storage unit automates optimization of storage based on multidimensional geographic information, which is difficult with human subjective judgment or simple region name matching, thereby aggregating region-specific AI know-how, achieving personalization of information, improving searchability and reusability, and enhancing overall system data quality. Application fields include region-specific AI recipe sharing services, tourism and regional promotion support, on-site response recipe storage during disasters, region-based management of educational AI content, and location-based AI support for creative production sites.

The storage unit can improve the accuracy of storage at the time of saving based on related literature of prompts and work processes. For example, the storage unit refers to related literature of prompts and work processes to improve the accuracy of storage. Related literature may include, for example, cited literature or reference materials, but is not limited thereto. For example, the storage unit refers to related literature and proposes an optimal storage method. The storage unit may also improve the accuracy of storage based on related literature. For example, the storage unit adjusts the order of storage by considering related literature. By referring to related literature, the accuracy of storage is improved. Some or all of the above-described processing in the storage unit may be performed using AI or without using AI. For example, the storage unit may use an AI model that takes related literature of prompts and work processes as input and outputs a storage method to improve storage accuracy. Specifically, the storage unit obtains literature information associated with prompts and work processes (e.g., DOI, paper title, author, publication year, summary text, reference URL, etc.) and structures them as feature vectors (e.g., BERT-based literature embedding vectors, TF-IDF score arrays, etc.). The storage unit inputs the related literature vector into a literature similarity AI model (e.g., Transformer for semantic similarity calculation, literature clustering AI) and dynamically determines storage formats (e.g., storage with literature references, grouping related literature), storage order (e.g., prioritizing recipes with more citations), and storage metadata (e.g., assignment of literature tags). Examples of input include literature title “High-accuracy summarization method”, DOI “10.1234/abcd.2024”, summary “This paper proposes a method to improve the accuracy of summarization AI”, etc. Examples of AI model output include storage format “with literature reference”, storage priority 0.91, literature tag “summarization AI”, etc. Based on these outputs, the storage unit executes optimization of the literature reference structure and storage order in the storage database. Internally, the AI model performs weighting of literature features, clustering, and optimization of storage efficiency. In subsequent processing, the storage unit collects storage history and user feedback and utilizes them as retraining data for the AI model. As a technical effect, the storage unit automates optimization of storage accuracy based on multidimensional literature information, which is difficult with human subjective judgment or simple literature reference, thereby improving information reliability, searchability and reusability, and overall system data quality. Application fields include literature-linked storage for AI recipe sharing services, reference material management in enterprise knowledge bases, literature reference storage for educational AI content, and evidence-based recipe storage for creative production support.

The ranking unit can estimate a user's emotion and adjust the criteria for ranking based on the estimated emotion of the user. For example, the ranking unit estimates the user's emotion and adjusts the criteria for ranking based on the estimated emotion. Emotion estimation may be realized using an emotion engine or generative AI, such as an emotion estimation function. Generative AI may include text generation AI (for example, LLM) or multimodal generative AI, but is not limited thereto. For example, the ranking unit may capture the user's facial expression with a camera and estimate the emotion using an emotion estimation algorithm. For example, the ranking unit may calculate an emotion score based on changes in facial expression. The ranking unit may also record the user's voice and estimate the emotion using voice analysis technology. For example, the ranking unit may analyze the tone and speed of the voice and calculate an emotion score. The ranking unit may also collect the user's biometric data (heart rate or skin conductance) with a sensor and estimate the emotion using an emotion estimation algorithm. For example, the ranking unit may calculate an emotion score based on heart rate variability. By adjusting the criteria for ranking according to the user's emotion, optimal ranking for the user can be achieved. Some or all of the above-described processing in the ranking unit may be performed using AI or without using AI. For example, the ranking unit may use an AI model that takes the user's emotion data as input and adjusts the criteria for ranking. Specifically, the ranking unit simultaneously acquires multiple sensor data for emotion estimation (e.g., facial expression image tensor (224×224×3), voice waveform data, heart rate time series array, skin conductance vector, etc.) and inputs them into a multimodal AI model (e.g., a network integrating image feature extraction CNN, voice feature extraction RNN, and MLP for biosignals). The ranking unit extracts features for each modality and outputs emotion labels (e.g., joy, anger, anxiety, relaxation, etc.) and emotion scores (e.g., continuous values from 0.0 to 1.0) in the integration layer. Examples of input include facial image tensor (224×224×3), voice spectrogram (128×256), heart rate array ([72, 75, 80, . . . ]), skin conductance vector ([0.12, 0.15, 0.10, . . . ]), etc. Examples of AI model output include emotion label “anxiety”, emotion score 0.72, and estimated confidence 0.93. Based on these outputs, the ranking unit dynamically adjusts the ranking criteria (e.g., weighting of evaluation scores, ranking criteria by user attribute, displaying challenging recipes at the top when the user is in a positive emotional state, prioritizing simple recipes when in a negative emotional state, etc.). Internally, the AI model performs emphasis of important features using attention mechanisms, optimization of estimation accuracy using loss functions, and dynamic adjustment of weight parameters. Examples of AI model output include a set of criteria weights (e.g., evaluation score=0.7, PV count=0.2, number of users=0.1), ranking criteria ID “emotion-adaptive”, etc. In subsequent processing, the adjusted ranking criteria are reflected in the ranking generation algorithm, and rankings optimized for each user are generated and displayed. As a technical effect, the ranking unit automates multimodal emotion estimation and real-time optimization of ranking criteria, which is difficult with human subjective judgment or uniform criteria, thereby improving user experience, increasing satisfaction and reliability of rankings, reducing churn rate, and enhancing overall system interaction efficiency. Application fields include emotion-adaptive ranking for AI recipe sharing services, stress care ranking for educational AI content, user state-adaptive ranking in medical and welfare fields, and emotion-linked ranking optimization for creative production support.

The ranking unit can improve the accuracy of ranking at the time of ranking based on the interrelationship between prompts and work processes. For example, the ranking unit improves the accuracy of ranking by considering the interrelationship between prompts and work processes. The interrelationship may include, for example, relevance or dependency, but is not limited thereto. For example, the ranking unit analyzes the relevance between prompts and work processes and proposes an optimal ranking method. The ranking unit may also improve the accuracy of ranking by considering the interrelationship between prompts and work processes. For example, the ranking unit adjusts the order of ranking based on the interrelationship between prompts and work processes. By considering the interrelationship between prompts and work processes, the accuracy of ranking is improved. Some or all of the above-described processing in the ranking unit may be performed using AI or without using AI. For example, the ranking unit may use an AI model that takes the interrelationship between prompts and work processes as input and outputs a ranking method to improve ranking accuracy. Specifically, the ranking unit uses a semantic similarity calculation AI model (e.g., BERT-based embedding vector generation model or co-occurrence frequency analysis algorithm) to quantitatively evaluate the relevance between prompts and work processes. The ranking unit generates feature vectors for each prompt and work process (e.g., 512-dimensional embedding vectors) and calculates relevance scores (e.g., 0.0 to 1.0) and dependency graphs using indicators such as cosine similarity or Jaccard coefficient. Examples of input include prompt “summary prompt”, work process “summarize with AI model A”, prompt “image generation prompt”, work process “generate with image generation AI”, etc. The AI model outputs, for example, a relevance score matrix (e.g., summary prompt-summary process=0.92, image generation prompt-image generation process=0.88), dependency graph (e.g., prompt A→work process A), etc. Based on the relevance scores and dependency graphs, the ranking unit dynamically optimizes the ranking order (e.g., consecutively ranking prompts and work processes with dependencies), ranking criteria (e.g., placing highly relevant combinations at the top), and ranking metadata (e.g., assigning relevance scores). Internally, the AI model performs emphasis of important features using attention mechanisms, optimization of relevance estimation accuracy using loss functions, and dynamic adjustment of weight parameters. Examples of AI model output include a ranking order list (e.g., summary type→image generation type), ranking group ID (e.g., Group A=summary related, Group B=image generation related), etc. In subsequent processing, the ranking unit collects history of improved ranking accuracy and user feedback and utilizes them as retraining data for the AI model. As a technical effect, the ranking unit automates optimization of ranking accuracy based on the interrelationship between prompts and work processes, which is difficult with human subjective judgment or simple uniform ranking, thereby improving consistency of rankings, searchability and reusability, and overall system ranking quality. Application fields include related recipe group ranking for AI recipe sharing services, dependency management ranking in enterprise knowledge bases, relevance ranking for educational AI content, and process-linked ranking optimization for creative production support.

The ranking unit can perform ranking at the time of ranking based on attribute information of the submitter of prompts and work processes. For example, the ranking unit performs ranking by considering the attribute information of the submitter of prompts and work processes. Attribute information may include, for example, age, gender, occupation, etc., but is not limited thereto. For example, the ranking unit proposes an optimal ranking method based on the submitter's field of expertise. The ranking unit may also improve the accuracy of ranking based on the submitter's years of experience. For example, the ranking unit adjusts the order of ranking by considering the attribute information of the submitter. By considering the attribute information of the submitter, the accuracy of ranking is improved. Some or all of the above-described processing in the ranking unit may be performed using AI or without using AI. For example, the ranking unit may use an AI model that takes the attribute information of the submitter as input and outputs a ranking method to perform ranking. Specifically, the ranking unit obtains attribute information of the submitter (e.g., age, gender, occupation, field of expertise, years of experience, affiliated organization, user ID, etc.) from a database and structures it as feature vectors (e.g., age=35, gender=1, occupation=2, field of expertise=natural language processing, years of experience=7 years, etc.). The ranking unit inputs the attribute information vector into a ranking optimization AI model (e.g., MLP for attribute clustering, decision tree, reinforcement learning algorithm, etc.) and dynamically determines the ranking format (e.g., categorization by field of expertise, assignment of ranking priority according to years of experience), ranking order (e.g., displaying expert recipes at the top), and ranking metadata (e.g., assignment of attribute tags). Examples of input include attribute vector (age=28, occupation=engineer, field of expertise=image generation, years of experience=3 years), prompt “image generation prompt”, work process “generate with image generation AI”, etc. Examples of AI model output include ranking category “image generation”, ranking priority 0.92, attribute tag “engineer·3 years”, etc. Based on these outputs, the ranking unit executes categorization of the ranking database and optimization of ranking order. Internally, the AI model performs weighting of attribute features, clustering, and optimization of ranking efficiency. In subsequent processing, the ranking unit collects ranking history and user feedback and utilizes them as retraining data for the AI model. As a technical effect, the ranking unit automates optimization of ranking based on multidimensional attribute information, which is difficult with human subjective judgment or simple attribute matching, thereby achieving personalization of information, improved searchability and reusability, and overall system ranking quality improvement. Application fields include attribute-linked ranking for AI recipe sharing services, field-specific ranking in enterprise knowledge bases, attribute-optimized ranking for educational AI content, and user attribute-adaptive ranking for creative production support.

The ranking unit can estimate a user's emotion and adjust the order of displaying ranking results based on the estimated emotion of the user. For example, the ranking unit estimates the user's emotion and adjusts the order of displaying ranking results based on the estimated emotion. Emotion estimation may be realized using an emotion engine or generative AI, such as an emotion estimation function. Generative AI may include text generation AI (for example, LLM) or multimodal generative AI, but is not limited thereto. For example, the ranking unit may capture the user's facial expression with a camera and estimate the emotion using an emotion estimation algorithm. For example, the ranking unit may calculate an emotion score based on changes in facial expression. The ranking unit may also record the user's voice and estimate the emotion using voice analysis technology. For example, the ranking unit may analyze the tone and speed of the voice and calculate an emotion score. The ranking unit may also collect the user's biometric data (heart rate or skin conductance) with a sensor and estimate the emotion using an emotion estimation algorithm. For example, the ranking unit may calculate an emotion score based on heart rate variability. By adjusting the display order according to the user's emotion, the display can be made easier for the user to view. Some or all of the above-described processing in the ranking unit may be performed using AI or without using AI. For example, the ranking unit may use an AI model that takes the user's emotion data as input and adjusts the order of displaying ranking results. Specifically, the ranking unit simultaneously acquires multiple sensor data for emotion estimation (e.g., facial expression image tensor (224×224×3), voice waveform data, heart rate time series array, skin conductance vector, etc.) and inputs them into a multimodal AI model (e.g., CNN+RNN+MLP integrated network). The ranking unit extracts features for each modality and outputs emotion labels (e.g., joy, anger, anxiety, relaxation, etc.) and emotion scores (e.g., continuous values from 0.0 to 1.0) in the integration layer. Examples of input include facial image tensor (224×224×3), voice spectrogram (128×256), heart rate array ([72, 75, 80, . . . ]), skin conductance vector ([0.12, 0.15, 0.10, . . . ]), etc. Examples of AI model output include emotion label “relaxation”, emotion score 0.85, and estimated confidence 0.95. Based on these outputs, the ranking unit dynamically determines the display order of ranking results (e.g., displaying challenging recipes at the top when the user is in a positive emotional state, prioritizing simple recipes when in a negative emotional state, etc.) and display format (e.g., concise display, detailed display, display with warning messages, etc.). Internally, the AI model performs emphasis of important features using attention mechanisms, optimization of estimation accuracy using loss functions, and dynamic adjustment of weight parameters. Examples of AI model output include a display order list (e.g., simple recipes→detailed recipes), display format ID “emotion-adaptive”, etc. In subsequent processing, the ranking unit collects selection history of display order and user feedback and utilizes them as retraining data for the AI model. As a technical effect, the ranking unit automates multimodal emotion estimation and real-time optimization of display order, which is difficult with human subjective judgment or uniform display, thereby improving user experience, understanding of ranking results, reducing stress, and enhancing overall system interaction efficiency. Application fields include AI recipe ranking display support, emotion-adaptive ranking display for educational AI content, stress care ranking display in medical and welfare fields, and user condition-adaptive ranking interfaces for creative production sites.

The ranking unit can perform ranking at the time of ranking by considering the geographic distribution of prompts and work processes. For example, the ranking unit performs ranking by considering the geographic distribution of prompts and work processes. Geographic distribution may include, for example, region-specific data or map display, but is not limited thereto. For example, the ranking unit prioritizes ranking of prompts and work processes related to geographically close locations. The ranking unit may also propose an optimal ranking method based on geographic distribution. For example, the ranking unit adjusts the order of ranking by considering geographic distribution. By considering geographic distribution, highly relevant information can be ranked. Some or all of the above-described processing in the ranking unit may be performed using AI or without using AI. For example, the ranking unit may use an AI model that takes the geographic distribution of prompts and work processes as input and outputs a ranking method to perform ranking. Specifically, the ranking unit obtains geographic location information associated with prompts and work processes (e.g., GPS coordinates, region name, landmark ID, indoor location estimation data via Wi-Fi/Bluetooth beacons, etc.) and structures them as feature vectors (e.g., 10-dimensional vectors including latitude, longitude, altitude, region category, time, etc.). The ranking unit inputs the geographic distribution vector into a geographic clustering AI model (e.g., K-means algorithm or BERT-based model for semantic similarity calculation) and dynamically determines ranking groups (e.g., region-specific clusters), ranking priority (e.g., prioritizing local recipes), and ranking metadata (e.g., assignment of region tags). Examples of input include GPS coordinates (35.6895, 139.6917), region category “urban area”, time “2024-06-01 14:00”, etc. Examples of AI model output include ranking group ID “urban area”, ranking priority 0.93, region tag “Tokyo”, etc. Based on these outputs, the ranking unit executes region-based partitioning of the ranking database and optimization of ranking order. Internally, the AI model performs weighting of geographic features, clustering, and optimization of ranking efficiency. In subsequent processing, the ranking unit collects ranking history and user feedback and utilizes them as retraining data for the AI model. As a technical effect, the ranking unit automates optimization of ranking based on multidimensional geographic information, which is difficult with human subjective judgment or simple region name matching, thereby aggregating region-specific AI know-how, achieving personalization of information, improving searchability and reusability, and enhancing overall system ranking quality. Application fields include region-specific AI recipe sharing services, tourism and regional promotion support, on-site response ranking during disasters, region-based ranking management for educational AI content, and location-based AI ranking support for creative production sites.

The ranking unit can improve the accuracy of ranking at the time of ranking based on related literature of prompts and work processes. For example, the ranking unit refers to related literature of prompts and work processes to improve the accuracy of ranking. Related literature may include, for example, cited literature or reference materials, but is not limited thereto. For example, the ranking unit refers to related literature and proposes an optimal ranking method. The ranking unit may also improve the accuracy of ranking based on related literature. For example, the ranking unit adjusts the order of ranking by considering related literature. By referring to related literature, the accuracy of ranking is improved. Some or all of the above-described processing in the ranking unit may be performed using AI or without using AI. For example, the ranking unit may use an AI model that takes related literature of prompts and work processes as input and outputs a ranking method to improve ranking accuracy. Specifically, the ranking unit obtains literature information associated with prompts and work processes (e.g., DOI, paper title, author, publication year, summary text, reference URL, etc.) and structures them as feature vectors (e.g., BERT-based literature embedding vectors, TF-IDF score arrays, etc.). The ranking unit inputs the related literature vector into a literature similarity AI model (e.g., Transformer for semantic similarity calculation, literature clustering AI) and dynamically determines ranking formats (e.g., ranking with literature references, grouping related literature), ranking order (e.g., prioritizing recipes with more citations), and ranking metadata (e.g., assignment of literature tags). Examples of input include literature title “High-accuracy summarization method”, DOI “10.1234/abcd.2024”, summary “This paper proposes a method to improve the accuracy of summarization AI”, etc. Examples of AI model output include ranking format “with literature reference”, ranking priority 0.91, literature tag “summarization AI”, etc. Based on these outputs, the ranking unit executes optimization of the literature reference structure and ranking order in the ranking database. Internally, the AI model performs weighting of literature features, clustering, and optimization of ranking efficiency. In subsequent processing, the ranking unit collects ranking history and user feedback and utilizes them as retraining data for the AI model. As a technical effect, the ranking unit automates optimization of ranking accuracy based on multidimensional literature information, which is difficult with human subjective judgment or simple literature reference, thereby improving information reliability, searchability and reusability, and overall system ranking quality. Application fields include literature-linked ranking for AI recipe sharing services, reference material ranking in enterprise knowledge bases, literature reference ranking for educational AI content, and evidence-based ranking for creative production support.

The aggregation unit can estimate a user's emotion and adjust the method of aggregation based on the estimated emotion of the user. For example, the aggregation unit estimates the user's emotion and adjusts the method of aggregation based on the estimated emotion. Emotion estimation may be realized using an emotion engine or generative AI, such as an emotion estimation function. Generative AI may include text generation AI (for example, LLM) or multimodal generative AI, but is not limited thereto. For example, the aggregation unit may capture the user's facial expression with a camera and estimate the emotion using an emotion estimation algorithm. For example, the aggregation unit may calculate an emotion score based on changes in facial expression. The aggregation unit may also record the user's voice and estimate the emotion using voice analysis technology. For example, the aggregation unit may analyze the tone and speed of the voice and calculate an emotion score. The aggregation unit may also collect the user's biometric data (heart rate or skin conductance) with a sensor and estimate the emotion using an emotion estimation algorithm. For example, the aggregation unit may calculate an emotion score based on heart rate variability. By adjusting the method of aggregation according to the user's emotion, optimal aggregation for the user can be achieved. Some or all of the above-described processing in the aggregation unit may be performed using AI or without using AI. For example, the aggregation unit may use an AI model that takes the user's emotion data as input and adjusts the method of aggregation. Specifically, the aggregation unit simultaneously acquires multiple sensor data for emotion estimation (e.g., facial expression image tensor (224×224×3), voice waveform data, heart rate time series array, skin conductance vector, etc.) and inputs them into a multimodal AI model (e.g., CNN+RNN+MLP integrated network). The aggregation unit extracts features for each modality and outputs emotion labels (e.g., joy, anger, anxiety, relaxation, etc.) and emotion scores (e.g., continuous values from 0.0 to 1.0) in the integration layer. Examples of input include facial image tensor (224×224×3), voice spectrogram (128×256), heart rate array ([72, 75, 80, . . . ]), skin conductance vector ([0.12, 0.15, 0.10, . . . ]), etc. Examples of AI model output include emotion label “anxiety”, emotion score 0.72, and estimated confidence 0.93. Based on these outputs, the aggregation unit dynamically determines the aggregation method (e.g., simple aggregation, detailed aggregation, selection of aggregation items according to emotional state, dynamic change of expression method for aggregation results, etc.). For example, when the user is anxious, the aggregation results are summarized concisely and reassuring expressions are selected. When the user is relaxed, detailed aggregation results and statistical background are displayed. Examples of AI model output include simple aggregation “Summary: This recipe has many highly efficient procedures.”, detailed aggregation “Success rate, failure rate, average required time for each procedure”, etc. In subsequent processing, the aggregation unit collects selection history of aggregation methods and user feedback and utilizes them as retraining data for the AI model. As a technical effect, the aggregation unit automates multimodal emotion estimation and real-time optimization of aggregation methods, which is difficult with human subjective judgment, thereby improving user experience, understanding of aggregation results, reducing stress, and enhancing overall system interaction efficiency. Application fields include AI recipe aggregation support, emotion-adaptive aggregation for educational AI content, stress care aggregation support in medical and welfare fields, and user condition-adaptive aggregation interfaces for creative production sites.

The aggregation unit can improve the accuracy of aggregation at the time of aggregation based on the interrelationship between prompts and work processes. For example, the aggregation unit improves the accuracy of aggregation by considering the interrelationship between prompts and work processes. The interrelationship may include, for example, relevance or dependency, but is not limited thereto. For example, the aggregation unit analyzes the relevance between prompts and work processes and proposes an optimal aggregation method. The aggregation unit may also improve the accuracy of aggregation by considering the interrelationship between prompts and work processes. For example, the aggregation unit adjusts the order of aggregation based on the interrelationship between prompts and work processes. By considering the interrelationship between prompts and work processes, the accuracy of aggregation is improved. Some or all of the above-described processing in the aggregation unit may be performed using AI or without using AI. For example, the aggregation unit may use an AI model that takes the interrelationship between prompts and work processes as input and outputs an aggregation method to improve aggregation accuracy. Specifically, the aggregation unit uses a semantic similarity calculation AI model (e.g., BERT-based embedding vector generation model or co-occurrence frequency analysis algorithm) to quantitatively evaluate the relevance between prompts and work processes. The aggregation unit generates feature vectors for each prompt and work process (e.g., 512-dimensional embedding vectors) and calculates relevance scores (e.g., 0.0 to 1.0) and dependency graphs using indicators such as cosine similarity or Jaccard coefficient. Examples of input include prompt “summary prompt”, work process “summarize with AI model A”, prompt “image generation prompt”, work process “generate with image generation AI”, etc. The AI model outputs, for example, a relevance score matrix (e.g., summary prompt-summary process=0.92, image generation prompt-image generation process=0.88), dependency graph (e.g., prompt A→work process A), etc. Based on the relevance scores and dependency graphs, the aggregation unit dynamically optimizes the aggregation order (e.g., consecutively aggregating prompts and work processes with dependencies), aggregation format (e.g., grouping related recipes for aggregation), and aggregation metadata (e.g., assigning relevance scores). Internally, the AI model performs emphasis of important features using attention mechanisms, optimization of relevance estimation accuracy using loss functions, and dynamic adjustment of weight parameters. Examples of AI model output include an aggregation order list (e.g., summary type→image generation type), aggregation group ID (e.g., Group A=summary related, Group B=image generation related), etc. In subsequent processing, the aggregation unit collects history of improved aggregation accuracy and user feedback and utilizes them as retraining data for the AI model. As a technical effect, the aggregation unit automates optimization of aggregation accuracy based on the interrelationship between prompts and work processes, which is difficult with human subjective judgment or simple uniform aggregation, thereby improving information consistency, searchability and reusability, and overall system data quality. Application fields include related recipe group aggregation for AI recipe sharing services, dependency management aggregation in enterprise knowledge bases, relevance aggregation for educational AI content, and process-linked aggregation optimization for creative production support.

The aggregation unit can estimate a user's emotion and adjust the frequency of aggregation based on the estimated emotion of the user. For example, the aggregation unit estimates the user's emotion and adjusts the frequency of aggregation based on the estimated emotion. Emotion estimation may be realized using an emotion engine or generative AI, such as an emotion estimation function. Generative AI may include text generation AI (for example, LLM) or multimodal generative AI, but is not limited thereto. For example, the aggregation unit may capture the user's facial expression with a camera and estimate the emotion using an emotion estimation algorithm. For example, the aggregation unit may calculate an emotion score based on changes in facial expression. The aggregation unit may also record the user's voice and estimate the emotion using voice analysis technology. For example, the aggregation unit may analyze the tone and speed of the voice and calculate an emotion score. The aggregation unit may also collect the user's biometric data (heart rate or skin conductance) with a sensor and estimate the emotion using an emotion estimation algorithm. For example, the aggregation unit may calculate an emotion score based on heart rate variability. By adjusting the frequency of aggregation according to the user's emotion, optimal aggregation for the user can be achieved. Some or all of the above-described processing in the aggregation unit may be performed using AI or without using AI. For example, the aggregation unit may use an AI model that takes the user's emotion data as input and adjusts the frequency of aggregation. Specifically, the aggregation unit simultaneously acquires multiple sensor data for emotion estimation (e.g., facial expression image tensor (224×224×3), voice waveform data, heart rate time series array, skin conductance vector, etc.) and inputs them into a multimodal AI model (e.g., CNN+RNN+MLP integrated network). The aggregation unit extracts features for each modality and outputs emotion labels (e.g., joy, anger, anxiety, relaxation, etc.) and emotion scores (e.g., continuous values from 0.0 to 1.0) in the integration layer. Examples of input include facial image tensor (224×224×3), voice spectrogram (128×256), heart rate array ([72, 75, 80, . . . ]), skin conductance vector ([0.12, 0.15, 0.10, . . . ]), etc. Examples of AI model output include emotion label “anxiety”, emotion score 0.72, and estimated confidence 0.93. Based on these outputs, the aggregation unit dynamically determines the aggregation frequency (e.g., reducing aggregation frequency to alleviate load during high stress, increasing aggregation frequency for detailed monitoring when relaxed, etc.). Examples of AI model output include aggregation frequency “every 10 minutes”, “every hour”, “every day”, etc. In subsequent processing, the aggregation unit collects selection history of aggregation frequency and user feedback and utilizes them as retraining data for the AI model. As a technical effect, the aggregation unit automates multimodal emotion estimation and real-time optimization of aggregation frequency, which is difficult with human subjective judgment, thereby improving user experience, optimizing aggregation load, reducing stress, and enhancing overall system operational efficiency. Application fields include AI recipe aggregation support, emotion-adaptive aggregation frequency control for educational AI content, stress care aggregation frequency adjustment in medical and welfare fields, and user condition-adaptive aggregation frequency optimization for creative production sites.

The aggregation unit can set weighting of aggregated data at the time of aggregation based on the submission timing of prompts and work processes. For example, the aggregation unit performs weighting of aggregated data based on the submission timing of prompts and work processes. Weighting may include, for example, importance or impact of data, but is not limited thereto. For example, the aggregation unit applies weighting to prompts and work processes submitted earlier. The aggregation unit may also reduce weighting for prompts and work processes submitted later. For example, the aggregation unit dynamically adjusts the weighting of aggregated data based on submission timing. By performing weighting of aggregated data based on submission timing, the accuracy of aggregation is improved. Some or all of the above-described processing in the aggregation unit may be performed using AI or without using AI. For example, the aggregation unit may use an AI model that takes the submission timing of prompts and work processes as input and outputs weighting to perform weighting of aggregated data. Specifically, the aggregation unit extracts submission time information of prompts and work processes received from the receiving unit (e.g., UNIX timestamp, ISO8601 format date and time, submission order index, etc.) from the database and structures it as submission timing vectors (e.g., submission date and time, elapsed time, batch ID, etc.). The aggregation unit inputs this submission timing information into a weighting determination AI model (e.g., recurrent neural network for time series analysis or weighted priority scoring algorithm). Examples of input include Prompt A (submission date and time 2024-06-01 10:00), Prompt B (submission date and time 2024-06-01 12:00), Prompt C (submission date and time 2024-06-01 09:30), etc. The AI model outputs, for example, a weighting list (e.g., C=0.95, A=0.90, B=0.85), etc. The aggregation unit adjusts the contribution of each data during aggregation operations according to the weighting list, emphasizing the impact of prompts and work processes submitted earlier. Internally, the AI model performs weighting of submission timing, batch processing optimization, and resource allocation control. Examples of AI model output include weighting “Prompt C=0.95, Prompt A=0.90, Prompt B=0.85”, etc. In subsequent processing, the aggregation unit collects weighting determination history and aggregation accuracy evaluation and utilizes them as retraining data for the AI model. As a technical effect, the aggregation unit automates optimization of weighting of aggregated data based on submission timing, which is difficult with manual work or simple uniform weighting, thereby improving overall system aggregation accuracy, maximizing the value of time series data, optimizing resource utilization, and enhancing user experience. Application fields include AI recipe aggregation support, enterprise business automation, aggregation of educational AI content, and time series weighting aggregation optimization for creative production support.

The display unit can estimate a user's emotion and adjust the display method based on the estimated emotion of the user. For example, the display unit estimates the user's emotion and adjusts the display method based on the estimated emotion. Emotion estimation may be realized using an emotion engine or generative AI, such as an emotion estimation function. Generative AI may include text generation AI (for example, LLM) or multimodal generative AI, but is not limited thereto. For example, the display unit may capture the user's facial expression with a camera and estimate the emotion using an emotion estimation algorithm. For example, the display unit may calculate an emotion score based on changes in facial expression. The display unit may also record the user's voice and estimate the emotion using voice analysis technology. For example, the display unit may analyze the tone and speed of the voice and calculate an emotion score. The display unit may also collect the user's biometric data (heart rate or skin conductance) with a sensor and estimate the emotion using an emotion estimation algorithm. For example, the display unit may calculate an emotion score based on heart rate variability. By adjusting the display method according to the user's emotion, optimal display for the user can be achieved. Some or all of the above-described processing in the display unit may be performed using AI or without using AI. For example, the display unit may use an AI model that takes the user's emotion data as input and adjusts the display method.

The display unit can select an optimal display method at the time of display based on the user's past operation history. For example, the display unit refers to the user's past operation history to select an optimal display method. Operation history may include, for example, past operation data or the period for which history is stored, but is not limited thereto. For example, the display unit proposes an optimal display method based on display methods previously used by the user. The display unit may also select the most efficient display method from the user's past operation history. For example, the display unit analyzes the user's past operation history and provides an optimal display method. By referring to the user's past operation history, an optimal display method can be provided. Some or all of the above-described processing in the display unit may be performed using AI or without using AI. For example, the display unit may use an AI model that takes the user's past operation history as input and selects a display method to select an optimal display method.

The display unit can estimate a user's emotion and determine the priority of display based on the estimated emotion of the user. For example, the display unit estimates the user's emotion and determines the priority of display based on the estimated emotion. Emotion estimation may be realized using an emotion engine or generative AI, such as an emotion estimation function. Generative AI may include text generation AI (for example, LLM) or multimodal generative AI, but is not limited thereto. For example, the display unit may capture the user's facial expression with a camera and estimate the emotion using an emotion estimation algorithm. For example, the display unit may calculate an emotion score based on changes in facial expression. The display unit may also record the user's voice and estimate the emotion using voice analysis technology. For example, the display unit may analyze the tone and speed of the voice and calculate an emotion score. The display unit may also collect the user's biometric data (heart rate or skin conductance) with a sensor and estimate the emotion using an emotion estimation algorithm. For example, the display unit may calculate an emotion score based on heart rate variability. By determining the priority of display according to the user's emotion, optimal display for the user can be achieved. Some or all of the above-described processing in the display unit may be performed using AI or without using AI. For example, the display unit may use an AI model that takes the user's emotion data as input and determines the priority of display.

The display unit can select an optimal display method at the time of display based on the user's device information. For example, the display unit selects an optimal display method by considering the user's device information. Device information may include, for example, device type or OS version, but is not limited thereto. For example, when the user is using a smartphone, the display unit provides a display method adapted to the screen size. The display unit may also provide a display method optimized for a large screen when the user is using a tablet. For example, when the user is using a smartwatch, the display unit provides a concise and highly visible display method. By considering the user's device information, an optimal display method can be provided. Some or all of the above-described processing in the display unit may be performed using AI or without using AI. For example, the display unit may use an AI model that takes the user's device information as input and selects a display method to select an optimal display method.

The search unit can estimate a user's emotion and adjust the display method of search results based on the estimated emotion of the user. For example, the search unit estimates the user's emotion and adjusts the display method of search results based on the estimated emotion. Emotion estimation may be realized, for example, by using an emotion estimation function with an emotion engine or generative AI. The generative AI may be a text generative AI (for example, LLM) or a multimodal generative AI, but is not limited to such examples. For example, the search unit may capture the user's facial expression with a camera and estimate the emotion using an emotion estimation algorithm. For example, the search unit may calculate an emotion score based on changes in facial expression. In addition, the search unit may record the user's voice and estimate the emotion using voice analysis technology. For example, the search unit may analyze the tone and speed of the voice and calculate an emotion score. Furthermore, the search unit may collect the user's biometric data (such as heart rate or skin electrical activity) with a sensor and estimate the emotion using an emotion estimation algorithm. For example, the search unit may calculate an emotion score based on fluctuations in heart rate. By adjusting the display method of search results according to the user's emotion, optimal search results can be obtained for the user. Some or all of the above-described processing in the search unit may be performed using AI or without using AI. For example, the search unit may use an AI model that takes the user's emotion data as input and adjusts the display method of search results.

The search unit can provide optimal search results based on the user's past search history during searching. For example, the search unit refers to the user's past search history to provide optimal search results. The search history may include, for example, past search data and the retention period of the history, but is not limited to such examples. For example, the search unit may propose optimal search results based on keywords previously searched by the user. In addition, the search unit can provide highly relevant search results based on the user's past search history. For example, the search unit analyzes the user's past search history and provides optimal search results. By referring to the user's past search history, optimal search results can be provided. Some or all of the above-described processing in the search unit may be performed using AI or without using AI. For example, the search unit may use an AI model that takes the user's past search history as input and outputs search results to provide optimal search results.

The search unit can estimate a user's emotion and determine the priority of search results based on the estimated emotion of the user. For example, the search unit estimates the user's emotion and determines the priority of search results based on the estimated emotion. Emotion estimation may be realized, for example, by using an emotion estimation function with an emotion engine or generative AI. The generative AI may be a text generative AI (for example, LLM) or a multimodal generative AI, but is not limited to such examples. For example, the search unit may capture the user's facial expression with a camera and estimate the emotion using an emotion estimation algorithm. For example, the search unit may calculate an emotion score based on changes in facial expression. In addition, the search unit may record the user's voice and estimate the emotion using voice analysis technology. For example, the search unit may analyze the tone and speed of the voice and calculate an emotion score. Furthermore, the search unit may collect the user's biometric data (such as heart rate or skin electrical activity) with a sensor and estimate the emotion using an emotion estimation algorithm. For example, the search unit may calculate an emotion score based on fluctuations in heart rate. By determining the priority of search results according to the user's emotion, optimal search results can be obtained for the user. Some or all of the above-described processing in the search unit may be performed using AI or without using AI. For example, the search unit may use an AI model that takes the user's emotion data as input and determines the priority of search results.

The search unit can provide optimal search results based on the user's geographic location information during searching. For example, the search unit provides optimal search results by taking into account the user's geographic location information. Geographic location information may include, for example, GPS data or location information services, but is not limited to such examples. For example, when the user is in a specific region, the search unit preferentially displays search results related to that region. In addition, the search unit can propose optimal search results based on the user's current location. For example, the search unit may refer to the user's geographic location information and filter highly relevant search results. By considering the user's geographic location information, optimal search results can be provided. Some or all of the above-described processing in the search unit may be performed using AI or without using AI. For example, the search unit may use an AI model that takes the user's geographic location information as input and outputs optimal search results.

The system according to the embodiment is not limited to the above-described examples, and various modifications are possible, for example, as follows.

The receiving unit can automatically search for and propose relevant external resources based on the user's input. For example, when the user inputs a specific prompt, relevant papers or articles are proposed. In addition, the receiving unit can provide tutorial videos or guidelines related to the work process input by the user. As a result, the user can efficiently obtain necessary information.

The analysis unit can automatically cluster similar prompts or work processes based on the user's input and propose them to the user. For example, the analysis unit groups other prompts similar to the prompt input by the user and presents them to the user. In addition, the analysis unit can group other work processes similar to the work process input by the user and present them to the user. As a result, the user can refer to ideas and methods of other users.

The storage unit can provide a version management function for recipes saved by the user. For example, each time the user updates a recipe, previous versions are saved, and the user can revert to a past version as needed. In addition, the storage unit can display the change history of the recipe and indicate to the user which parts have been changed. As a result, the user can easily manage the change history of recipes.

The ranking unit can collect user feedback and reflect it in the ranking criteria. For example, when a user leaves a rating or comment on a recipe, the feedback is reflected in the ranking score. In addition, the ranking unit can analyze user feedback and propose improvements to the recipe. As a result, ranking that reflects user opinions becomes possible.

The display unit can automatically optimize the display content according to the screen size of the user's device. For example, on a small smartphone screen, important information is displayed preferentially, and detailed information is displayed in a collapsed format. On a large tablet or desktop screen, all information can be displayed at once. As a result, the user can comfortably view information on any device.

The receiving unit can estimate a user's emotion and provide real-time feedback on the input content based on the estimated emotion of the user. For example, when the user feels anxious, the receiving unit displays an encouraging message for the input content. In addition, when the user is excited, the receiving unit can display a message of praise for the input content. As a result, support tailored to the user's emotion is provided.

The analysis unit can estimate a user's emotion and adjust the presentation method of analysis results based on the estimated emotion of the user. For example, when the user is tired, the analysis unit summarizes and displays the analysis results concisely. In addition, when the user is excited, the analysis unit can display detailed analysis results. As a result, presentation of analysis results tailored to the user's emotion becomes possible.

The storage unit can estimate a user's emotion and automatically tag recipes to be stored based on the estimated emotion of the user. For example, when the user is happy, the storage unit tags the recipe with “success” or “satisfaction.” In addition, when the user feels anxious, the storage unit can tag the recipe with “improvement” or “caution.” As a result, recipe management tailored to the user's emotion becomes possible.

The ranking unit can estimate a user's emotion and adjust the method of displaying ranking results based on the estimated emotion of the user. For example, when the user is feeling down, the ranking unit displays the ranking results with a positive message. In addition, when the user is excited, the ranking unit can display detailed ranking results. As a result, display of ranking results tailored to the user's emotion becomes possible.

The display unit can estimate a user's emotion and adjust the color and design of the display content based on the estimated emotion of the user. For example, when the user is relaxed, the display unit uses a calm color scheme. In addition, when the user is excited, the display unit can use a bright and lively color scheme. As a result, customization of display content tailored to the user's emotion becomes possible.

The following is a brief description of the processing flow of Example of the Embodiment.
Step 1: The receiving unit receives prompts and work process inputs for the user to utilize generative AI. The prompts include question formats and instruction formats, and the work processes include step-by-step procedures and types of work.
Step 2: The analysis unit analyzes the information received by the receiving unit using generative AI. The analysis includes data analysis methods and analysis objectives, and analyzes the content of prompts and work processes to extract information to be stored as recipes.
Step 3: The storage unit stores the information analyzed by the analysis unit as recipes. The recipes include cooking recipes and work procedure manuals, and the analyzed information is stored in a database so that the user can refer to it later.
Step 4: The ranking unit ranks the recipes stored by the storage unit. The ranking includes evaluation criteria and scoring methods, and aggregates the PV and number of users of the recipes to create rankings.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the above-mentioned elements, including the receiving unit, analysis unit, storage unit, and ranking unit, is implemented by at least one of, for example, the smart device 14 and the data processing apparatus 12. For example, the receiving unit is implemented by a control unit 46A of the smart device 14 and receives inputs of prompts and work processes for the user to utilize generative AI. The analysis unit is implemented, for example, by a specific processing unit 290 of the data processing apparatus 12 and analyzes the input information. The storage unit stores information in a database 24 of the data processing apparatus 12. The ranking unit is implemented, for example, by the specific processing unit 290 of the data processing apparatus 12 and ranks the stored recipes. The correspondence between each unit and the device or control unit is not limited to the above examples and various modifications are possible.

### Second Embodiment

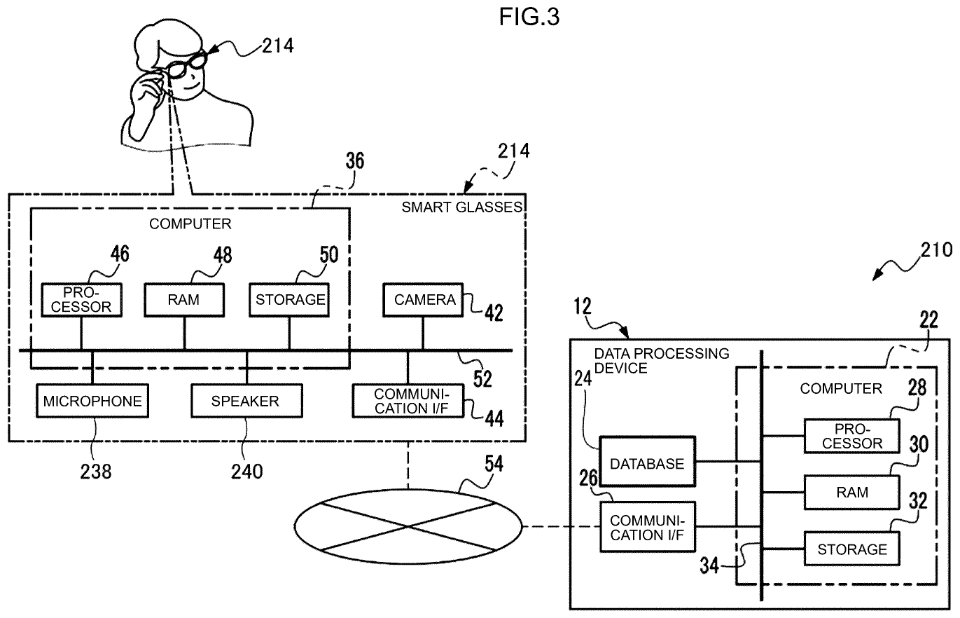

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

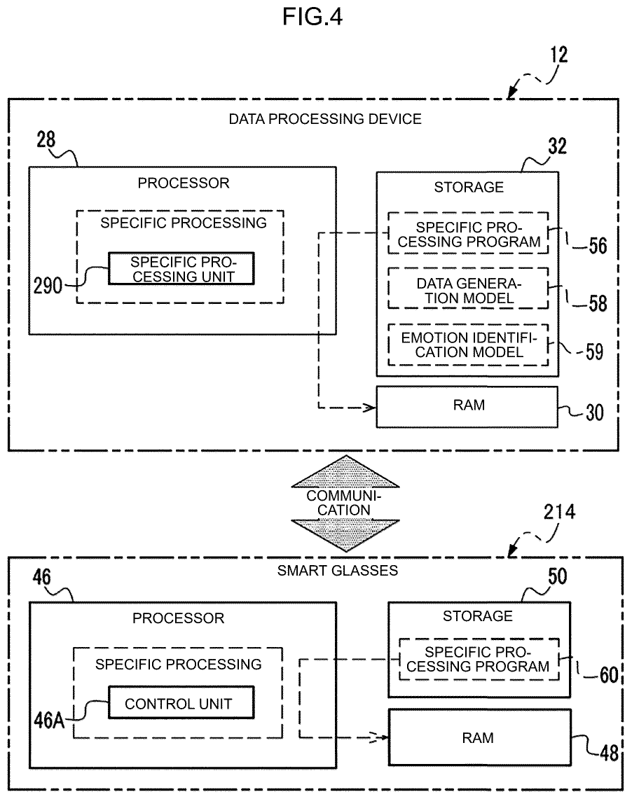

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the above-mentioned elements, including the receiving unit, analysis unit, storage unit, and ranking unit, is implemented by at least one of, for example, the smart glasses 214 and the data processing apparatus 12. For example, the receiving unit is implemented by a control unit 46A of the smart glasses 214 and receives inputs of prompts and work processes for the user to utilize generative AI. The analysis unit is implemented, for example, by a specific processing unit 290 of the data processing apparatus 12 and analyzes the input information. The storage unit stores information in a database 24 of the data processing apparatus 12. The ranking unit is implemented, for example, by the specific processing unit 290 of the data processing apparatus 12 and ranks the stored recipes. The correspondence between each unit and the device or control unit is not limited to the above examples and various modifications are possible.

### Third Embodiment

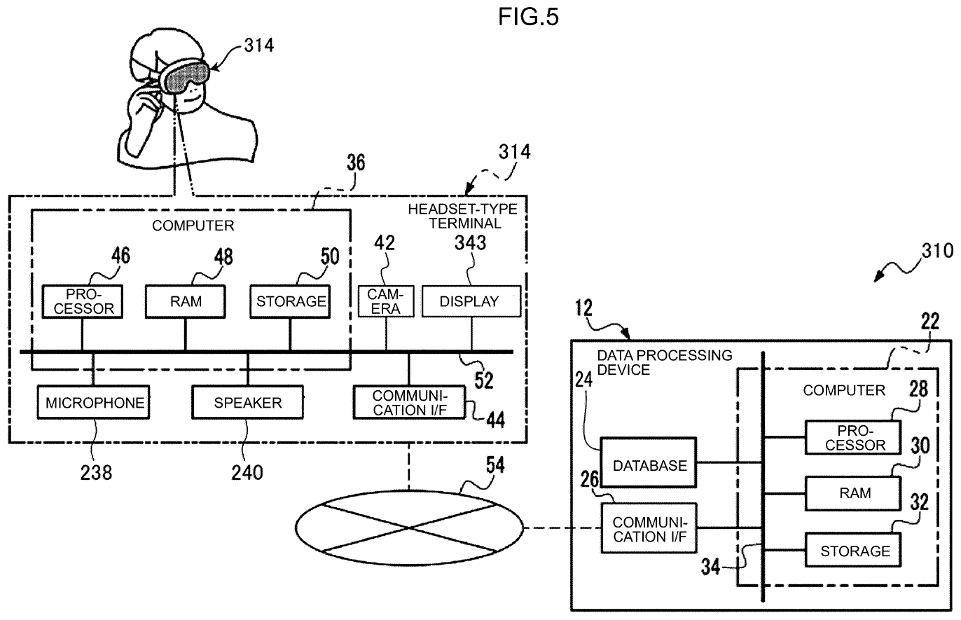

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

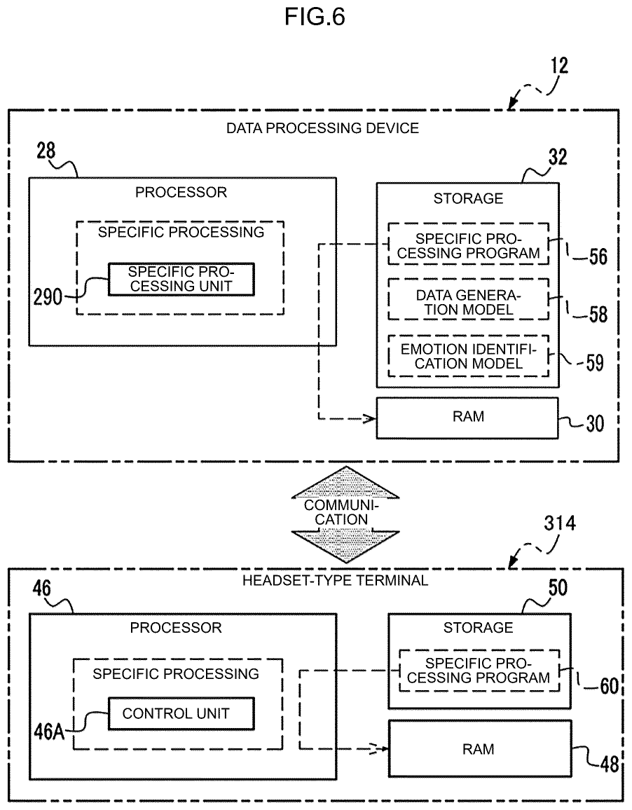

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the above-mentioned elements, including the receiving unit, analysis unit, storage unit, and ranking unit, is implemented by at least one of, for example, the headset-type terminal 314 and the data processing apparatus 12. For example, the receiving unit is implemented by a control unit 46A of the headset-type terminal 314 and receives inputs of prompts and work processes for the user to utilize generative AI. The analysis unit is implemented, for example, by a specific processing unit 290 of the data processing apparatus 12 and analyzes the input information. The storage unit stores information in a database 24 of the data processing apparatus 12. The ranking unit is implemented, for example, by the specific processing unit 290 of the data processing apparatus 12 and ranks the stored recipes. The correspondence between each unit and the device or control unit is not limited to the above examples and various modifications are possible.

### Fourth Embodiment

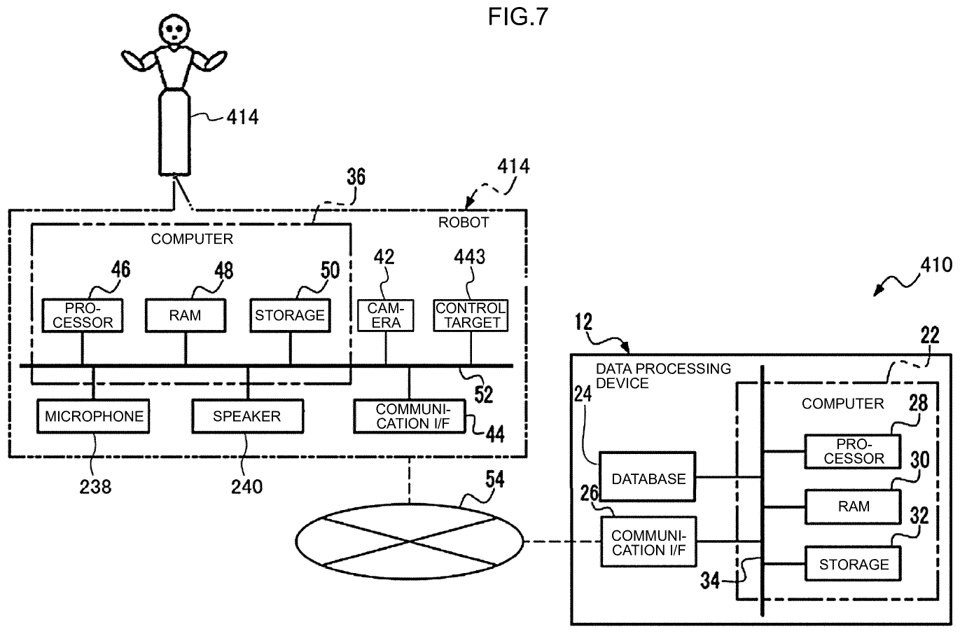

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

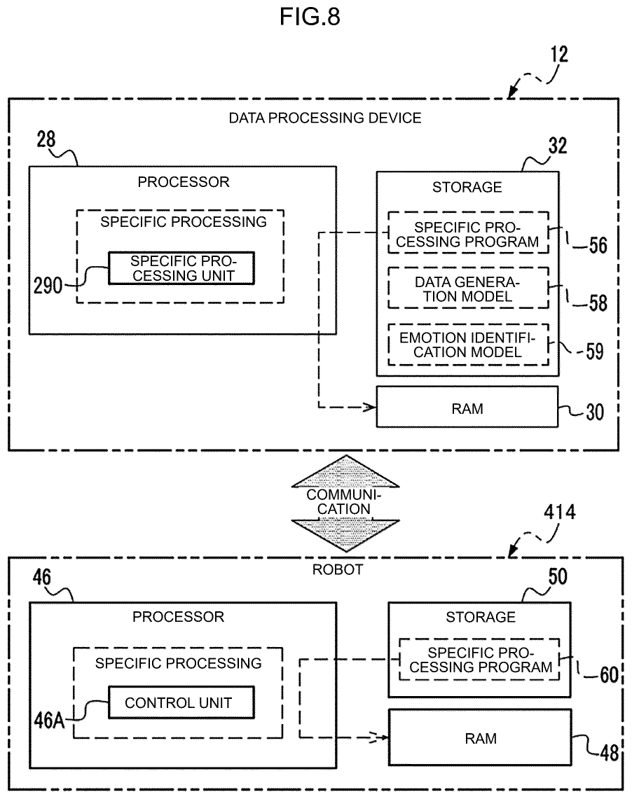

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the above-mentioned elements, including the receiving unit, analysis unit, storage unit, and ranking unit, is implemented by at least one of, for example, the robot 414 and the data processing apparatus 12. For example, the receiving unit is implemented by a control unit 46A of the robot 414 and receives inputs of prompts and work processes for the user to utilize generative AI. The analysis unit is implemented, for example, by a specific processing unit 290 of the data processing apparatus 12 and analyzes the input information. The storage unit stores information in a database 24 of the data processing apparatus 12. The ranking unit is implemented, for example, by the specific processing unit 290 of the data processing apparatus 12 and ranks the stored recipes. The correspondence between each unit and the device or control unit is not limited to the above examples and various modifications are possible.

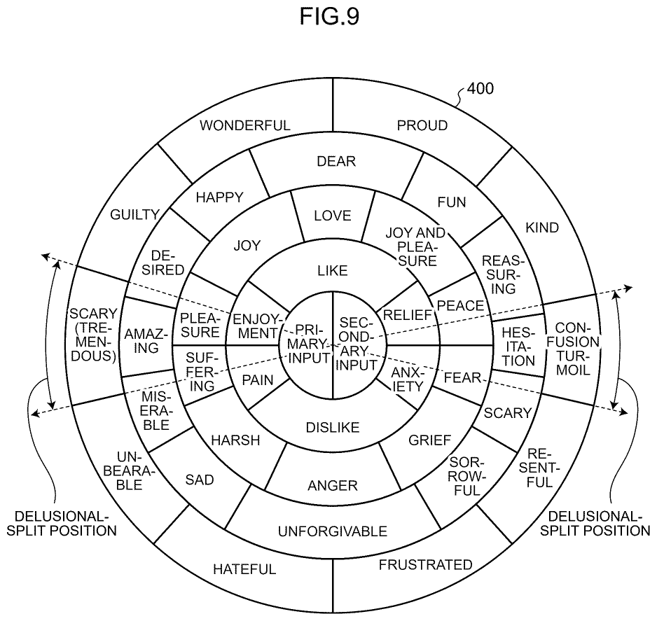

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

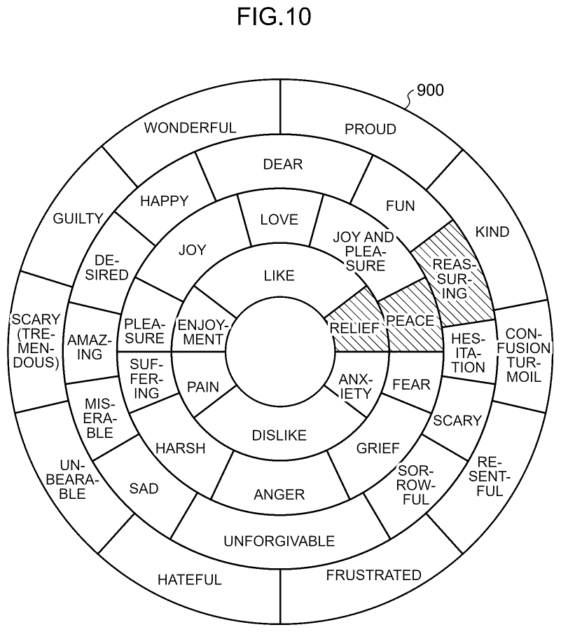

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1) A system comprising: a receiving unit configured to receive prompts and work process inputs; an analysis unit configured to analyze information received by the receiving unit; a storage unit configured to store information analyzed by the analysis unit as recipes; and a ranking unit configured to rank recipes stored by the storage unit.
(Supplementary Note 2) The system according to Supplementary Note 1, wherein the ranking unit comprises an aggregation unit configured to aggregate page views (PV) or the number of users of the recipes.
(Supplementary Note 3) The system according to Supplementary Note 2, wherein the ranking unit comprises a display unit configured to display rankings based on the aggregated data.
(Supplementary Note 4) The system according to Supplementary Note 1, wherein the storage unit comprises a search unit configured to allow a user to search for recipes.
(Supplementary Note 5) The system according to Supplementary Note 1, wherein the analysis unit is configured to analyze prompts and work processes using generative AI.
(Supplementary Note 6) The system according to Supplementary Note 1, wherein the storage unit is configured to store analyzed information in a database.
(Supplementary Note 7) The system according to Supplementary Note 1, wherein the receiving unit is configured to estimate a user's emotion and change the timing of input of prompts and work processes based on the estimated emotion of the user.
(Supplementary Note 8) The system according to Supplementary Note 1, wherein the receiving unit is configured to analyze a user's past input history and propose an optimal input method.
(Supplementary Note 9) The system according to Supplementary Note 1, wherein the receiving unit is configured to perform filtering based on the user's current project or field of interest when inputting prompts and work processes.
(Supplementary Note 10) The system according to Supplementary Note 1, wherein the receiving unit is configured to estimate a user's emotion and determine the priority of prompts and work processes to be input based on the estimated emotion of the user.
(Supplementary Note 11) The system according to Supplementary Note 1, wherein the receiving unit is configured to prioritize the input of highly relevant information based on the user's geographic location information when inputting prompts and work processes.
(Supplementary Note 12) The system according to Supplementary Note 1, wherein the receiving unit is configured to input relevant information based on the user's social media activity when inputting prompts and work processes.
(Supplementary Note 13) The system according to Supplementary Note 1, wherein the analysis unit is configured to estimate a user's emotion and adjust the method of expression of analysis based on the estimated emotion of the user.
(Supplementary Note 14) The system according to Supplementary Note 1, wherein the analysis unit is configured to change the level of detail of analysis based on the importance of prompts and work processes.
(Supplementary Note 15) The system according to Supplementary Note 1, wherein the analysis unit is configured to apply different analysis algorithms according to the category of prompts and work processes during analysis.
(Supplementary Note 16) The system according to Supplementary Note 1, wherein the analysis unit is configured to estimate a user's emotion and adjust the length of analysis based on the estimated emotion of the user.
(Supplementary Note 17) The system according to Supplementary Note 1, wherein the analysis unit is configured to set the priority of analysis based on the submission timing of prompts and work processes.
(Supplementary Note 18) The system according to Supplementary Note 1, wherein the analysis unit is configured to adjust the order of analysis based on the relevance of prompts and work processes during analysis.
(Supplementary Note 19) The system according to Supplementary Note 1, wherein the storage unit is configured to estimate a user's emotion and determine the priority of recipes to be stored based on the estimated emotion of the user.
(Supplementary Note 20) The system according to Supplementary Note 1, wherein the storage unit is configured to improve the accuracy of storage based on the interrelationship between prompts and work processes during storage.
(Supplementary Note 21) The system according to Supplementary Note 1, wherein the storage unit is configured to perform storage based on attribute information of the submitter of prompts and work processes during storage.
(Supplementary Note 22) The system according to Supplementary Note 1, wherein the storage unit is configured to estimate a user's emotion and adjust the display method of recipes to be stored based on the estimated emotion of the user.
(Supplementary Note 23) The system according to Supplementary Note 1, wherein the storage unit is configured to perform storage in consideration of the geographic distribution of prompts and work processes during storage.
(Supplementary Note 24) The system according to Supplementary Note 1, wherein the storage unit is configured to improve the accuracy of storage based on related literature of prompts and work processes during storage.
(Supplementary Note 25) The system according to Supplementary Note 1, wherein the ranking unit is configured to estimate a user's emotion and adjust the criteria for ranking based on the estimated emotion of the user.
(Supplementary Note 26) The system according to Supplementary Note 1, wherein the ranking unit is configured to improve the accuracy of ranking based on the interrelationship between prompts and work processes during ranking.
(Supplementary Note 27) The system according to Supplementary Note 1, wherein the ranking unit is configured to perform ranking based on attribute information of the submitter of prompts and work processes during ranking.
(Supplementary Note 28) The system according to Supplementary Note 1, wherein the ranking unit is configured to estimate a user's emotion and adjust the order of displaying ranking results based on the estimated emotion of the user.
(Supplementary Note 29) The system according to Supplementary Note 1, wherein the ranking unit is configured to perform ranking in consideration of the geographic distribution of prompts and work processes during ranking.
(Supplementary Note 30) The system according to Supplementary Note 1, wherein the ranking unit is configured to improve the accuracy of ranking based on related literature of prompts and work processes during ranking.
(Supplementary Note 31) The system according to Supplementary Note 2, wherein the aggregation unit is configured to estimate a user's emotion and adjust the method of aggregation based on the estimated emotion of the user.
(Supplementary Note 32) The system according to Supplementary Note 2, wherein the aggregation unit is configured to improve the accuracy of aggregation based on the interrelationship between prompts and work processes during aggregation.
(Supplementary Note 33) The system according to Supplementary Note 2, wherein the aggregation unit is configured to estimate a user's emotion and adjust the frequency of aggregation based on the estimated emotion of the user.
(Supplementary Note 34) The system according to Supplementary Note 2, wherein the aggregation unit is configured to set weighting of aggregated data based on the submission timing of prompts and work processes during aggregation.
(Supplementary Note 35) The system according to Supplementary Note 3, wherein the display unit is configured to estimate a user's emotion and adjust the display method based on the estimated emotion of the user.
(Supplementary Note 36) The system according to Supplementary Note 3, wherein the display unit is configured to select an optimal display method based on the user's past operation history during display.
(Supplementary Note 37) The system according to Supplementary Note 3, wherein the display unit is configured to estimate a user's emotion and determine the priority of display based on the estimated emotion of the user.
(Supplementary Note 38) The system according to Supplementary Note 3, wherein the display unit is configured to select an optimal display method based on the user's device information during display.
(Supplementary Note 39) The system according to Supplementary Note 4, wherein the search unit is configured to estimate a user's emotion and adjust the display method of search results based on the estimated emotion of the user.
(Supplementary Note 40) The system according to Supplementary Note 4, wherein the search unit is configured to provide optimal search results based on the user's past search history during search.
(Supplementary Note 41) The system according to Supplementary Note 4, wherein the search unit is configured to estimate a user's emotion and determine the priority of search results based on the estimated emotion of the user.
(Supplementary Note 42) The system according to Supplementary Note 4, wherein the search unit is configured to provide optimal search results based on the user's geographic location information during search.

What is claimed is:

1. A system comprising:
a communication interface configured to communicate with a client terminal via a packet-switched network;
a memory storing a data generation model comprising a Transformer-based architecture obtained by deep learning on a neural network;
a database; and
circuitry configured to:
receive, from the client terminal via the communication interface and the packet-switched network, first data packets comprising text data;
extract a feature vector from the text data by inputting the text data into the data generation model;
store, in the database, the text data and the feature vector;
receive, from the client terminal via the communication interface and the packet-switched network, a query request;
retrieve, from the database, access frequency data associated with stored records;
generate response data comprising record identifiers ranked according to the access frequency data; and
transmit the response data to the client terminal via the communication interface and the packet-switched network.

2. The system according to claim 1, wherein the text data comprises prompt data for utilizing generative AI and workflow sequence data comprising step-by-step procedures for AI utilization.

3. The system according to claim 1, wherein the circuitry is further configured to tokenize the text data, convert the text data into an embedding vector comprising a 512-dimensional floating-point array, and input the embedding vector into the data generation model.

4. The system according to claim 1, wherein the data generation model comprises at least one of a convolutional neural network, a recurrent neural network, or a large language model having one billion to one hundred billion parameters.

5. The system according to claim 1, wherein the circuitry is further configured to classify the text data into a category by inputting the text data into the data generation model, the category comprising at least one of text generation, image generation, audio generation, summarization, or translation.

6. The system according to claim 1, wherein the access frequency data comprises at least one of a page view count comprising unique access counts and repeat access counts, or a user count comprising unique user identifier counts and active user counts.

7. The system according to claim 1, wherein the circuitry is further configured to apply a ranking algorithm comprising at least one of weighted scoring or time-series trend correction to the access frequency data to generate the response data.

8. The system according to claim 1, wherein the memory further stores an emotion identification model, and wherein the circuitry is further configured to estimate an emotion of a user by applying the emotion identification model to sensor data received from the client terminal, and to adjust a timing of receiving the first data packets based on the estimated emotion.

9. The system according to claim 8, wherein the circuitry is further configured to determine a priority of the text data to be received based on the estimated emotion, such that when the estimated emotion indicates stress, the circuitry prioritizes receiving text data having a high importance attribute.

10. The system according to claim 1, wherein the circuitry is further configured to analyze a past input history of the user stored in the database and propose an optimal input method based on the past input history, the input method comprising at least one of text input or voice input.

11. The system according to claim 1, wherein the circuitry is further configured to receive, from the client terminal via the communication interface, project identifier data, and to filter the stored records based on the project identifier data before generating the response data.

12. The system according to claim 1, wherein the circuitry is further configured to receive geographic location information from the client terminal via the communication interface, and to adjust a priority of the stored records in the response data based on a relevance score calculated from the geographic location information.

13. The system according to claim 1, wherein the circuitry is further configured to receive social media activity data of the user from the client terminal via the communication interface, and to adjust the response data based on interest topics extracted from the social media activity data using a natural language processing model.

14. The system according to claim 1, wherein the memory further stores an emotion identification model, and wherein the circuitry is further configured to estimate an emotion of a user by applying the emotion identification model to sensor data received from the client terminal, and to adjust a level of detail of the feature vector extraction based on the estimated emotion.

15. The system according to claim 1, wherein the circuitry is further configured to apply different analysis algorithms according to a category of the text data, such that for text data in a text generation category, the circuitry applies a text classification algorithm, and for text data in an image generation category, the circuitry applies an image prompt analysis algorithm.

16. The system according to claim 1, wherein the circuitry is further configured to store, in the database, metadata associated with the text data, the metadata comprising at least one of a creation timestamp, a user identifier, or a version number, and to perform duplicate elimination based on the feature vector before storing.

17. The system according to claim 1, wherein the circuitry is further configured to receive, from the client terminal via the communication interface, a search query, convert the search query into a query vector using the data generation model, and perform a similarity search between the query vector and feature vectors stored in the database to identify matching records.

18. A system comprising:
a communication interface configured to communicate, via a packet-switched network conforming to at least one of a 5G, Wi-Fi, or Bluetooth communication standard, with a client terminal comprising a touch panel, a microphone, a speaker, a camera having a CMOS image sensor, and a display;
a processor;
a random-access memory;
a memory storing a data generation model comprising a Transformer-based architecture obtained by deep learning on a neural network, and an emotion identification model;
a database; and
circuitry configured to:
receive, from the client terminal via the communication interface and the packet-switched network, first data packets comprising text data;
tokenize the text data and extract a feature vector from the text data by inputting the text data into the data generation model;
store, in the database, the text data, the feature vector, and metadata comprising at least one of a creation timestamp or a user identifier;
estimate an emotion of a user by applying the emotion identification model to at least one of voice data captured by the microphone or image data captured by the camera;
receive, from the client terminal via the communication interface, a query request;
retrieve, from the database, access frequency data comprising at least one of page view counts or user counts associated with stored records;
generate response data comprising record identifiers ranked according to the access frequency data, the response data being adapted based on the estimated emotion; and
transmit the response data to the client terminal via the communication interface, the response data causing the client terminal to present the response data to the user via at least one of the display or the speaker.

19. The system according to claim 18, wherein the data generation model comprises at least one of a text generation AI, an image generation AI, or a multimodal generation AI, and wherein the data generation model is a fine-tuned model configured to output inference results from prompts without instructions.

20. A method performed by circuitry of a system comprising a communication interface, a memory storing a data generation model comprising a Transformer-based architecture obtained by deep learning on a neural network, and a database, the method comprising:
receiving, from a client terminal via the communication interface and a packet-switched network, first data packets comprising text data;
extracting a feature vector from the text data by inputting the text data into the data generation model;
storing, in the database, the text data and the feature vector;
receiving, from the client terminal via the communication interface and the packet-switched network, a query request;
retrieving, from the database, access frequency data associated with stored records;
generating response data comprising record identifiers ranked according to the access frequency data; and
transmitting the response data to the client terminal via the communication interface and the packet-switched network.
